(19) United States
(12) Patent Application Publication
(10) Pub. No.: US 2023/0110465 A1
(43) Pub. Date: Apr. 13, 2023

(54) TIRE

(71) Applicant: The Yokohama Rubber Co., LTD., Tokyo (JP)

(72) Inventor: Tsuyoto SHIMIZU, Kanagawa (JP)

(21) Appl. No.: 17/907,352

(22) PCT Filed: Apr. 1, 2021
(86) PCT No.: PCT/JP2021/014222

§ 371 Date: Sep. 26, 2022

(30) Foreign Application Priority Data
Apr. 1, 2020 (JP) 2020-066220

(51) Int. Cl. B60C 11/03; B60C 11/00

(52) U.S. Cl. CPC B60C 11/0332; B60C 11/0008; B60C 2011/0016; B60C 2011/0341

(57) ABSTRACT

In a cross-sectional view of a tire, a line connecting, by a single arc, a ground contact edge in a shoulder land, and midpoints of center and middle lands in a width direction is a profile. A distance between intersection points of the profile and lines extended from groove walls, on sides of the center land, of a main groove adjacent to both ends of the center land in the width direction is defined as Wc. Ends of the center land and of the middle land on both sides of the main groove are recessed toward the inner side in the radial direction relative to the profile, the recess of the middle land end is larger than the recess of the center land end, and a range of 0.03Wc from the center land end on the middle land side does not touch the ground.

### TECHNICAL FIELD

The present technology relates to a tire.

### BACKGROUND ART

In general, good steering stability performance can be obtained by making the contact patch shape of the tire appropriate. Japan Patent No. 5387707 discloses a technology for improving the contact patch shape by allowing the land portion to project toward the outer side in the tire radial direction with respect to the standard contour line of the entire tread portion.

The tire described in Japan Patent No. 5387707 includes a land portion projecting toward the outer side in the tire radial direction. However, since the projection amount is not large, the contact patch shape cannot be significantly improved, and there is room for improvement from the viewpoint of achieving both dry steering stability performance and wet steering stability performance in a compatible manner.

### SUMMARY

The present technology provides a tire capable of achieving both dry steering stability performance and wet steering stability performance in a compatible manner.

A tire according to a certain aspect of the present technology is a tire including: a plurality of circumferential main grooves provided in a tread portion, the plurality of circumferential main grooves extending in a tire circumferential direction; and a plurality of land portions defined by the plurality of circumferential main grooves, the plurality of land portions including: a center land portion closest to a tire equatorial plane; a first shoulder land portion including one ground contact edge of ground contact edges on both sides in a tire width direction with respect to the tire equatorial plane; and a first middle land portion between the first shoulder land portion and the center land portion, in a tire meridian cross-sectional view, a line connecting, by a single arc, a ground contact edge located in the first shoulder land portion, a midpoint of a length of the center land portion in the tire width direction, and a midpoint of a length of the first middle land portion in the tire width direction being defined as a first virtual profile, an end portion of the center land portion on a side of the first middle land portion being recessed toward an inner side in a tire radial direction relative to the first virtual profile, an end portion of the first middle land portion on a side of the center land portion being recessed toward the inner side in the tire radial direction relative to the first virtual profile, a recess amount of the end portion of the center land portion on the side of the first middle land portion being larger than a recess amount of the end portion of the first middle land portion on the side of the center land portion, and in the tire meridian cross-sectional view, a distance between intersection points of the first virtual profile and extension lines extended from groove walls, on sides of the center land portion, of circumferential main grooves adjacent to both end portions of the center land portion in the tire width direction being defined as Wc, and a ground contact edge of the center land portion being located on a more inner side than a position at a distance of 0.03Wc from the end portion of the center land portion on the side of the first middle land portion.

Preferably, in the tire meridian cross-sectional view, a distance between intersection points of the first virtual profile and extension lines extended from groove walls, on sides of the first middle land portion, of circumferential main grooves adjacent to both end portions of the first middle land portion in the tire width direction is defined as Wa, and a ground contact edge of the first middle land portion is located on a more inner side than a position at a distance of 0.03Wa from the end portion of the first middle land portion on the side of the center land portion.

Preferably, a difference between the recess amount of the end portion of the center land portion on the side of the first middle land portion and the recess amount of the end portion of the first middle land portion on the side of the center land portion is 0.1 mm or more and 0.8 mm or less.

Preferably, a groove width of the circumferential main groove adjacent to the end portion of the center land portion in the tire width direction is equal to or larger than a groove width of a circumferential main groove adjacent to the first shoulder land portion.

Preferably, a length of the center land portion in the tire width direction is 105% or more and 120% or less of a length of the first middle land portion in the tire width direction.

Preferably, an end portion of the first shoulder land portion on the inner side in the tire width direction is recessed toward the inner side in the tire radial direction relative to the first virtual profile, and a recess amount of the end portion of the center land portion on an outer side in the tire width direction is larger than a recess amount of the end portion of the first shoulder land portion on the inner side in the tire width direction.

Preferably, an end portion of the first middle land portion on a side of the first shoulder land portion is recessed toward the inner side in the tire radial direction relative to the first virtual profile, and a recess amount of the end portion of the first middle land portion on the side of the first shoulder land portion is equal to or larger than a recess amount of the end portion of the first shoulder land portion on a side of the first middle land portion.

Preferably, the first shoulder land portion includes a lug groove extending in the tire width direction, the lug groove includes a chamfer in a groove depth direction and a groove width direction, and a chamfer length in the groove width direction is larger than a chamfer length in the groove depth direction.

Preferably, the tire further includes: a second shoulderland portion including another ground contact edge of the ground contact edges on both sides in the tire width direction with respect to the tire equatorial plane; and a second middle land portion between the second shoulder land portion and the center land portion, wherein in the tire meridian cross-sectional view, a line connecting, by a single arc, a ground contact edge located in the second shoulder land portion, the midpoint of the length of the center land portion in the tire width direction, and a midpoint of a length of the second middle land portion in the tire width direction is defined as a second virtual profile, an end portion of the center land portion on a side of the second middle land portion is recessed toward the inner side in the tire radial direction relative to the second virtual profile, an end portion of the second middle land portion on a side of the center land portion is recessed toward the inner side in the tire radial direction relative to the second virtual profile, a recess amount of the end portion of the center land portion on the side of the second middle land portion is larger than a recess amount of the end portion of the second middle land portion on the side of the center land portion, and in the tire meridian cross-sectional view, a distance between intersection points of the second virtual profile and the extension lines extended from the groove walls, on the sides of the center land portion, of the circumferential main grooves adjacent to both end portions of the center land portion in the tire width direction is defined as Wc′, and a ground contact edge of the center land portion is located on a more inner side than a position at a distance of 0.03Wc′ from the end portion of the center land portion on the side of the second middle land portion.

Preferably, in the tire meridian cross-sectional view, a distance between intersection points of the second virtual profile and extension lines extended from groove walls, on sides of the second middle land portion, of circumferential main grooves adjacent to both end portions of the second middle land portion in the tire width direction is defined as Wb, and a ground contact edge of the second middle land portion is located on a more inner side than a position at a distance of 0.03Wb from the end portion of the second middle land portion on the side of the center land portion.

Preferably, a difference between the recess amount of the end portion of the center land portion on the side of the second middle land portion and the recess amount of the end portion of the second middle land portion on the side of the center land portion is 0.1 mm or more and 0.8 mm or less.

Preferably, a groove width of the circumferential main groove adjacent to the end portion of the center land portion in the tire width direction is equal to or larger than a groove width of a circumferential main groove adjacent to the second shoulder land portion.

Preferably, a length of the center land portion in the tire width direction is 105% or more and 120% or less of a length of the second middle land portion in the tire width direction.

Preferably, an end portion of the second shoulder land portion on the inner side in the tire width direction is recessed toward the inner side in the tire radial direction relative to the second virtual profile, and a recess amount of the end portion of the center land portion on the outer side in the tire width direction is larger than a recess amount of the end portion of the second shoulder land portion on the inner side in the tire width direction.

Preferably, an end portion of the second middle land portion on a side of the second shoulder land portion is recessed toward the inner side in the tire radial direction relative to the second virtual profile, and a recess amount of the end portion of the second middle land portion on the side of the second shoulder land portion is equal to or larger than a recess amount of the end portion of the second shoulder land portion on a side of the second middle land portion.

Preferably, the second shoulder land portion includes a lug groove extending in the tire width direction, the lug groove includes a chamfer in a groove depth direction and a groove width direction, and a chamfer length in the groove width direction is larger than a chamfer length in the groove depth direction.

Preferably, rubber constituting the tread portion has a hardness of 65 or more at 20° C.

The tire according to the present technology can achieve both dry steering stability performance and wet steering stability performance in a compatible manner.

### BRIEF DESCRIPTION OF DRAWINGS

FIG. 1 is a cross-sectional view in a tire meridian direction illustrating a tire according to an embodiment of the present technology.

FIG. 2 is a plan view illustrating an example of a tread surface of the tire illustrated in FIG. 1.

FIG. 3 is a diagram for describing a midpoint of a land portion.

FIG. 4 is a diagram for describing a midpoint of another land portion.

FIG. 5 is a diagram for describing a recess at an end portion of a land portion.

FIG. 6 is a diagram for describing a recess at an end portion of a land portion.

FIG. 7 is a diagram for describing a recess at an end portion of a land portion.

FIG. 8 is a diagram for describing a recess at an end portion of a land portion.

FIG. 9 is an enlarged meridian cross-sectional view of a center land portion, a middle land portion, and a shoulder land portion.

FIG. 10 is a diagram illustrating an example of a cross-section of a lug groove of a shoulder land portion.

FIG. 11 is a diagram illustrating an example of a cross-section of a lug groove of a shoulder land portion.

FIG. 12 is a diagram illustrating an example of a contact patch shape of the tire according to the present embodiment.

FIG. 13 is a diagram illustrating an example of a contact patch shape of a tire according to a comparative example.

### DETAILED DESCRIPTION

Embodiments of the present technology will be described in detail below with reference to the drawings. In the embodiments described below, identical or similar components to those of other embodiments have identical reference signs, and descriptions of those components will be either simplified or omitted. The present technology is not limited by the embodiments. Constituents of the embodiments include elements that are substantially identical or that can be substituted and easily conceived by one skilled in the art. Note that it is possible to combine the configurations described below as desired. Moreover, various omissions, substitutions, and changes to the configurations can be carried out within the scope of the present technology.

### Tire

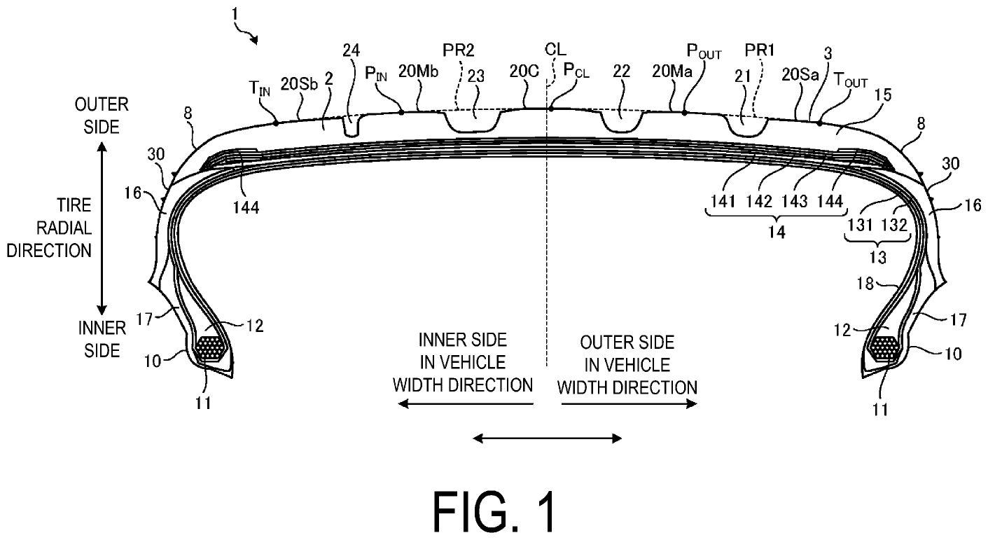

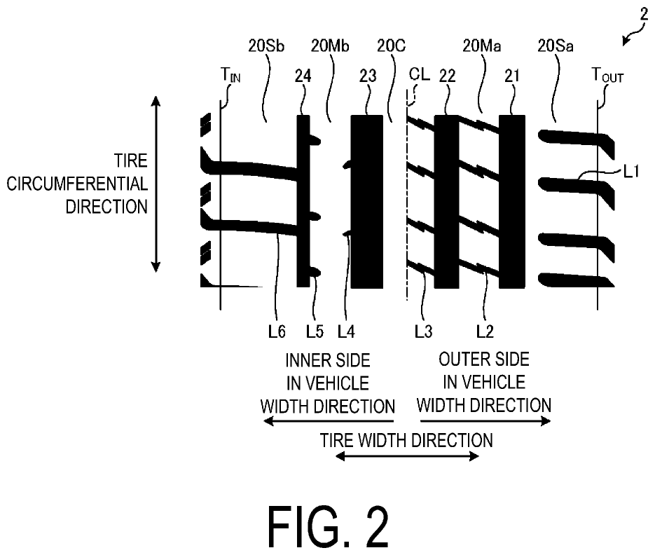

FIG. 1 is a cross-sectional view in a tire meridian direction illustrating a tire according to an embodiment of the present technology. FIG. 1 is a cross-sectional view of a half region in a tire radial direction. FIG. 2 is a plan view illustrating an example of a tread surface of the tire 1 illustrated in FIG. 1. Additionally, FIGS. 1 and 2 illustrate a radial tire for a passenger vehicle as an example of a tire.

In FIG. 1, a cross-section in the tire meridian direction is defined as a cross-section of the tire 1 taken along a plane that includes a rotation axis of the tire 1 (not illustrated). Further, a tire equatorial plane CL is defined as a plane that is perpendicular to the tire rotation axis and passes through a midpoint between measurement points of a tire cross-sectional width specified by JATMA (Japan Automobile Tire Manufacturers Association). The tire equatorial plane CL refers to a plane that is orthogonal to the rotation axis of the pneumatic tire 1 and passes through a center of a tire width of the tire 1.

Hereinafter, the tire radial direction refers to the direction orthogonal to the rotation axis (not illustrated) of the tire 1. An inner side in the tire radial direction refers to the side toward the rotation axis in the tire radial direction. An outer side in the tire radial direction refers to the side away from the rotation axis in the tire radial direction. Moreover, a tire circumferential direction refers to the circumferential direction with the rotation axis as the central axis. In addition, a tire width direction refers to a direction parallel with the rotation axis. An inner side in the tire width direction refers to the side toward the tire equatorial plane (tire equatorial line) CL in the tire width direction, and an outer side in the tire width direction refers to the side away from the tire equatorial plane CL in the tire width direction.

Furthermore, an outer side in the vehicle width direction and an inner side in the vehicle width direction are defined as vehicle width directions when the tire is mounted on a vehicle. Additionally, left and right regions demarcated by the tire equatorial plane CL are defined as an outer side region in the vehicle width direction and an inner side region in the vehicle width direction, respectively. Furthermore, the tire includes a mounting direction indicator (not illustrated) that indicates the tire mounting direction with respect to a vehicle. Examples of the mounting direction indicator include a mark and a recess/protrusion on a sidewall portion of the tire. For example, Regulation No. 30 of the Economic Commission for Europe Regulation (ECE R30) mandates that a vehicle mounting direction indicator be provided on the sidewall portion on the outer side in the vehicle width direction in a case where the tire is mounted on a vehicle.

In FIG. 1, a point T_{OUT} is a ground contact edge on the outer side in the vehicle width direction. A point T_{IN} is a ground contact edge on the inner side in the vehicle width direction. The ground contact edges refer to both outermost edges in the tire width direction in a region in which a tread surface 3 of a tread portion 2 of the tire 1 contacts the road surface when the tire 1 is mounted on a specified rim, inflated to a specified internal pressure, and loaded with 70% of a specified load. The ground contact edge is continuous in the tire circumferential direction.

The specified rim refers to a “standard rim” specified by JATMA, a “Design Rim” specified by the Tire and Rim Association, Inc. (TRA), or a “Measuring Rim” specified by the European Tyre and Rim Technical Organisation (ETRTO). Additionally, the specified internal pressure refers to a “maximum air pressure” specified by JATMA, the maximum value in “TIRE LOAD LIMITS AT VARIOUS COLD INFLATION PRESSURES” specified by TRA, or “INFLATION PRESSURES” specified by ETRTO. Additionally, the specified load refers to a “maximum load capacity” specified by JATMA, the maximum value in “TIRE LOAD LIMITS AT VARIOUS COLD INFLATION PRESSURES” specified by TRA, or “LOAD CAPACITY” specified by ETRTO. However, in JATMA, in the case of a tire for a passenger vehicle, the specified internal pressure is an air pressure of 180 kPa, and the specified load is 88% of the maximum load capacity at the specified internal pressure.

The tread surface 3 is provided with a plurality of circumferential main grooves 21, 22, 23, and 24. A plurality ofland portions 20C, 20Ma, 20Mb, 20Sa, and 20Sb are defined by the circumferential main grooves 21, 22, 23 and 24. The land portion 20C is the center land portion closest to the tire equatorial plane CL. When a circumferential main groove is provided on the tire equatorial plane CL, the land portions on both sides of the circumferential main groove in the tire width direction are the land portions closest to the tire equatorial plane CL, that is, the center land portions. The land portion 20Sa is a first shoulder land portion including one ground contact edge T_{OUT} of the ground contact edges T_{OUT} and T_{IN} on both sides in the tire width direction with respect to the tire equatorial plane CL. 20Ma denotes a first middle land portion located between the first shoulder land portion 20S a and the center land portion 20C. The land portion 20Sb is a second shoulder land portion including the other ground contact edge T_{IN} of the ground contact edges T_{OUT} and T_{IN} on both sides in the tire width direction with respect to the tire equatorial plane CL. The land portion 20Mb is a second middle land portion between the second shoulder land portion 20Sb and the center land portion 20C. The land portions 20C, 20Ma, 20Mb, 20Sa and 20Sb each may be a rib-like land portion continuous in the tire circumferential direction, or may be a land portion including block rows divided by a groove extending in the tire width direction.

The tire 1 has an annular structure with the tire rotation axis being as the center, and includes a pair of bead cores 11, 11, a pair of bead fillers 12, 12, a carcass layer 13, a belt layer 14, a tread rubber 15, a pair of sidewall rubbers 16, 16, and a pair of rim cushion rubbers 17, 17 (see FIG. 1).

The pair of bead cores 11, 11 include one or a plurality of bead wires made of steel and wound annularly multiple times and are embedded in bead portions 10 to configure the cores of the left and right bead portions 10. The pair of bead fillers 12, 12 are disposed on the outer side in the tire radial direction of the pair of bead cores 11, 11 to reinforce the bead portions 10.

The carcass layer 13 has a single layer structure including one carcass ply, or a multilayer structure including a plurality of carcass plies being layered, and the carcass layer 13 extends in a toroidal shape between the bead cores 11, 11 at the left and right, and constitutes the backbone of the tire. Additionally, both end portions of the carcass layer 13 are turned back toward outer sides in the tire width direction to wrap the bead cores 11 and the bead fillers 12, and are fixed. Moreover, the carcass ply of the carcass layer 13 is made by covering a plurality of carcass cords made of steel or an organic fiber material (for example, aramid, nylon, polyester, or rayon) with a coating rubber and performing a rolling process on the carcass cords, and has a cord angle of 80 degrees or more and 100 degrees or less. The cord angle is defined as the inclination angle in the longitudinal direction of the carcass cord with respect to the tire circumferential direction.

In the configuration of FIG. 1, the carcass layer 13 has a single-layer structure including a single carcass ply, and a turned-back portion 132 thereof extends along the outer circumferential surface of a body portion 131. A terminating end portion of the turned-back portion 132 is sandwiched between the belt layer 14 and the body portion 131.

The belt layer 14 is formed by layering a plurality of belt plies, and is disposed around the outer circumference of the carcass layer 13. The belt layer 14 includes a pair of cross belts 141, 142, a belt cover 143, and a belt edge cover 144. In this example, a plurality of the belt covers 143 are provided.

The pair of cross belts 141, 142 are made by covering a plurality of belt cords made of steel or an organic fiber material with a coating rubber and performing a rolling process on the belt cords, and have a cord angle of 15 degrees or more and 55 degrees or less as an absolute value. Further, the pair of cross belts 141, 142 have cord angles (defined as inclination angles in longitudinal directions of the belt cords with respect to the tire circumferential direction) of mutually opposite signs and are layered such that the longitudinal directions of the belt cords intersect each other (so-called crossply structure). Furthermore, the pair of cross belts 141, 142 are disposed in a layered manner on an outer side in the tire radial direction of the carcass layer 13.

The belt cover 143 and the belt edge covers 144 are made by covering a plurality of belt cover cords made of steel or an organic fiber material with coating rubber, and have a cord angle 0 degree or more and 10 degrees or less as an absolute value. Additionally, for example, a strip material is formed of one or a plurality of belt cover cords covered with coating rubber, and the belt cover 143 and the belt edge covers 144 are made by winding this strip material multiple times and in a spiral-like manner in the tire circumferential direction around outer circumferential surfaces of the cross belts 141, 142. Additionally, the belt cover 143 is disposed completely covering the cross belts 141, 142, and the pair of belt edge covers 144, 144 are disposed covering the left and right edge portions of the cross belts 141, 142 from the outer side in the tire radial direction.

The tread rubber 15 is disposed in the outer circumferences of the carcass layer 13 and the belt layer 14 in the tire radial direction and constitutes a tread portion 2 of the tire. Shoulder portions 8 are located at both end portions of the tread portion 2 in the tire width direction.

The pair of sidewall rubbers 16, 16 are disposed on respective outer sides in the tire width direction of the carcass layer 13 and constitute left and right sidewall portions 30. For example, in the configuration of FIG. 1, the end portion of the sidewall rubber 16 on the outer side in the tire radial direction is disposed in the lower layer of the tread rubber 15 and is sandwiched between the belt layer 14 and the carcass layer 13. However, no such limitation is intended, and the end portion of the sidewall rubber 16 on the outer side in the tire radial direction may be disposed in the outer layer of the tread rubber 15 and exposed in a buttress portion (not illustrated). The buttress portion is a non-ground contact region of the connection portion between the profile of the tread portion 2 and the profile of the sidewall portion 30.

The pair of rim cushion rubbers 17, 17 extend from an inner side in the tire radial direction of the left and right bead cores 11, 11 and the turned back portions 132 of the carcass layer 13 toward the outer side in the tire width direction, and constitute rim fitting surfaces of the bead portions 10. The rim fitting surface is a contact surface of the bead portion 10 with the rim flange (not illustrated).

The innerliner 18 is an air permeation preventing layer disposed on the tire inner surface and covering the carcass layer 13, and suppresses oxidation caused by exposure of the carcass layer 13 and also prevents leaking of the air in the tire. Additionally, the innerliner 18 is made of, for example, a rubber composition containing butyl rubber as a main component, a thermoplastic resin, and a thermoplastic elastomer composition containing an elastomer component blended with a thermoplastic resin.

### Tread Pattern

As illustrated in FIG. 2, the tire 1 includes, on a tread surface, the plurality of circumferential main grooves 21, 22, 23 and 24 extending in the tire circumferential direction and the plurality of land portions 20C, 20Ma, 20Mb, 20Sa and 20Sb defined by these circumferential main grooves 21, 22, 23 and 24.

As illustrated in FIG. 2, the land portion 20C closest to the tire equatorial plane CL is the center land portion. The land portion 20Sa including the ground contact edge T_{OUT} on the outer side in the vehicle width direction with respect to the tire equatorial plane CL is the first shoulder land portion. The land portion between the center land portion 20C and the first shoulder land portion 20Sa is the first middle land portion 20Ma. The land portion 20Sb including the ground contact edge T_{IN} on the inner side in the vehicle width direction with respect to the tire equatorial plane CL is the second shoulder land portion. The land portion between the center land portion 20C and the second shoulder land portion 20Sb is the second middle land portion 20Mb.

As illustrated in FIG. 2, each land portion may be provided with a lug groove. The lug groove is a lateral groove extending in the tire width direction, and opens when the tire comes into contact with the ground, and functions as a groove. The first shoulder land portion 20Saincludes a lug groove L1. One end portion of the lug groove L1 is terminated at the first shoulder land portion 20S a. The other end portion of the lug groove L1 extends to the outer side of the ground contact edge T_{OUT} in the vehicle width direction. The first middle land portion 20Ma is provided with a lug groove L2. One end portion of the lug groove L2 is open to the circumferential main groove 21. The other end portion of the lug groove L2 is open to the circumferential main groove 22. The center land portion 20C is provided with a lug groove L3. One end portion of the lug groove L3 is terminated at the center land portion 20C. The other end portion of the lug groove L3 is open to the circumferential main groove 22. The second middle land portion 20Mb includes lug grooves L4 and L5. One end portion of the lug groove L4 and one end portion of the lug groove L5 are terminated at the second middle land portion 20Mb. The other end portion of the lug groove L4 is open to the circumferential main groove 23. The other end portion of the lug groove L5 is open to the circumferential main groove 24. The second shoulder land portion 20Sb is provided with a lug groove L6. One end portion of the lug groove L6 is terminated at the second shoulder land portion 20Sb. The other end portion of the lug groove L6 extends to the inner side of the ground contact edge T_{IN} in the vehicle width direction. By providing these lug grooves L1 to L6, drainage performance can be ensured.

Here, the groove width of the circumferential main groove 23 adjacent to the end portion of the center land portion 20C in the tire width direction is preferably equal to or larger than the groove width of the circumferential main groove 21 adjacent to the first shoulder land portion 20S a. Further, the groove width of the circumferential main groove 23 is equal to or larger than the groove width of the circumferential main groove 24 adjacent to the second shoulder land portion 20Sb. When the circumferential main groove is provided on the tire equatorial plane CL, the groove width of the circumferential main groove is preferably equal to or larger than the groove width of the circumferential main groove adjacent to the shoulder land portion. By making the groove width of the circumferential main groove for receiving the water discharged in the center land portion 20C wider than the groove width of the other circumferential main grooves, the drainage performance can be further improved.

The circumferential main grooves 21, 22, 23 and 24 have a groove width of 4.0 mm or more and 24.6 mm or less, and a groove depth of 5.5 mm or more and 8.0 mm or less. The circumferential main grooves 21, 22, 23, and 24 may be grooves provided with a wear indicator, or may be narrow grooves without a wear indicator.

The groove width is measured as a distance between groove walls opposed to each other in a groove opening portion when the tire is mounted on a specified rim, inflated to a specified internal pressure, and in an unloaded state. In a configuration in which the groove opening portion includes a notch portion or a chamfered portion, the groove width is measured with intersection points between an extension line of the tread contact surface and extension lines of the groove walls as measurement points, in a cross-sectional view parallel with the groove width direction and the groove depth direction.

The groove depth is measured as a distance from the tread contact surface to a maximum groove depth position when the tire is mounted on a specified rim, inflated to the specified internal pressure, and in an unloaded state. Additionally, in a configuration in which a groove bottom includes partial recess/projection portions or a sipe, the groove depth is measured excluding the partial recess/projection portions or the sipe.

### Tread Rubber

The hardness of the rubber constituting the tread portion 2 is preferably 65 or more. If the hardness of the rubber constituting the tread portion 2 is lower than the above, the bulging portion of the land portion, which has been a non-ground contact region under a normal load, is crushed under a high load. This is not preferable because the non-ground contact region becomes small, and the effect of achieving both wet steering stability performance and dry steering stability performance in a compatible manner becomes small. The hardness mentioned above is JIS (Japanese Industrial Standard)-A hardness which is durometer hardness measured at a temperature of 20° C. using a type A durometer in accordance with JIS K 6253.

### Virtual Profile

Returning to FIG. 1, a line connecting, by a single arc, the three points of the ground contact edge T_{OUT} located on the first shoulder land portion 20Sa on the outer side in the vehicle width direction, the midpoint P_{CL} of the length of the center land portion 20C in the tire width direction, and the midpoint P_{OUT} of the length of the first middle land portion 20Ma in the tire width direction is defined as a first virtual profile PR1. The first virtual profile PR1 is a virtual profile on the outer side in the vehicle width direction from the tire equatorial plane CL. Further, a line connecting, by a single arc, the three points of the ground contact edge T_{IN} located on the second shoulder land portion 20Sb on the inner side in the vehicle width direction, the midpoint P_{CL} of the length of the center land portion 20C in the tire width direction, and the midpoint P_{IN} of the length of the second middle land portion 20Mb in the tire width direction is defined as a second virtual profile PR2. The second virtual profile PR2 is a virtual profile on the inner side in the vehicle width direction from the tire equatorial plane CL.

### Midpoint of Land Portion

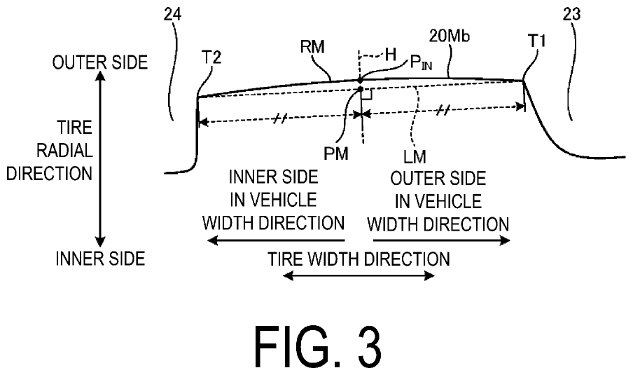

Here, the midpoint of the land portion is defined as follows. FIG. 3 is a diagram for describing the midpoint of the land portion. FIG. 3 illustrates a meridian cross-section of the second middle land portion 20Mb as an example of the land portion. In FIG. 3, the end portion of the second middle land portion 20Mb on the circumferential main groove 23 side, that is, on the outer side in the vehicle width direction is defined as T1. Further, the end portion of the second middle land portion 20Mb on the circumferential main groove 24 side, that is, on the inner side in the vehicle width direction is defined as T2. The distance between the end portion T1 and the end portion T2 is a length LM of the second middle land portion 20Mb in the tire width direction. The intersection point of the normal line H from the midpoint PM of the length LM toward the road contact surface RM of the second middle land portion 20Mb and the road contact surface RM is the midpoint P_{IN} of the second middle land portion 20Mb. The midpoint P_{CL} of the center land portion 20C and the midpoint P_{OUT} of the first middle land portion 20Ma illustrated in FIG. 1 are also defined in the same manner as above.

In the example illustrated in FIG. 3, the maximum projection position of the second middle land portion 20Mb and the midpoint P_{IN} coincide with each other. However, the midpoint defined as described above does not always coincide with the maximum projection position of the land portion.

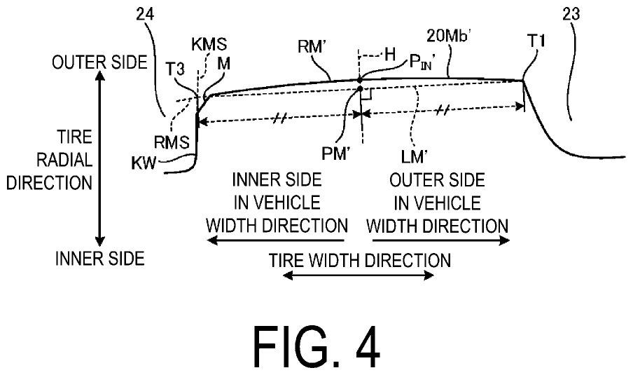

Here, when a chamfer or a notch is provided at the end portion of the land portion, the midpoint is defined as follows. FIG. 4 is a diagram illustrating a midpoint of another land portion. FIG. 4 illustrates a meridian cross-section of another second middle land portion 20Mb′. As illustrated in FIG. 4, a chamfer M is provided at the inner end portion of the second middle land portion 20Mb′ in the vehicle width direction. The midpoint of the land portion having the chamfer M in this way is defined as follows. The intersection point T3 of an extension line KMS extended from a groove wall KM and an extension line RMS extended from a road contact surface RM′ is defined as a virtual edge. The distance between the end portion T1 and the intersection point T3 is a length LM′ of the second middle land portion 20Mb′ in the tire width direction. The intersection point of a normal line H from a midpoint PM′ of the length LM′ toward the road contact surface RM′ of the second middle land portion 20Mb′ and the road contact surface RM′ is the midpoint P_{IN}′ of the second middle land portion 20Mb′. The midpoint is defined in the same manner as above when a notch is provided at the end portion of the land portion.

### Recess at End Portion of Land Portion

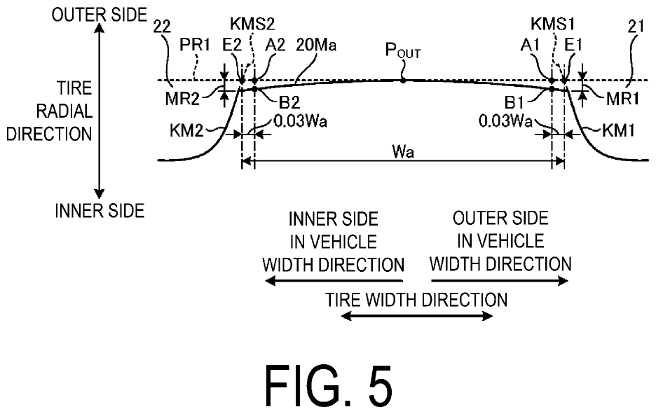

FIGS. 5 to 8 are views for describing a recess at an end portion of the land portion. FIG. 5 illustrates a meridian cross-section of the first middle land portion 20Ma as an example of the land portion. In FIG. 5, the end portions of the first middle land portion 20Ma in the tire width direction are recessed toward the inner side in the tire radial direction relative to the first virtual profile PR1. In FIG. 5, the recess amount (maximum value) from the first virtual profile PR1 at the outer end portion of the first middle land portion 20Ma in the vehicle width direction is defined as MR1. Further, the recess amount (maximum value) from the first virtual profile PR1 at the inner end portion of the first middle land portion 20Ma in the vehicle width direction is defined as MR2. As illustrated in FIG. 5, in the meridian cross-sectional view, both end portions of the first middle land portion 20Ma are recessed toward the inner side in the tire radial direction, so that the first middle land portion 20Ma has a convex shape.

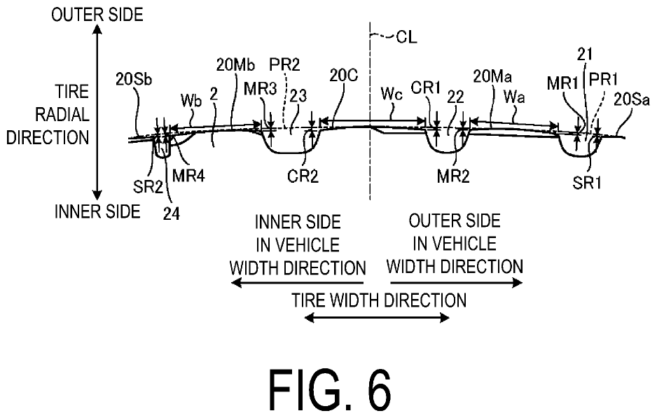

As illustrated in FIG. 6, the outer end portion of the center land portion 20C in the vehicle width direction is also recessed toward the inner side in the tire radial direction relative to the first virtual profile PR1 in the same manner as described above. The recess amount (maximum value) from the first virtual profile PR1 at the outer end portion of the center land portion 20C in the vehicle width direction is defined as CR1. The inner end of the center land portion 20C in the vehicle width direction is also recessed toward the inner side in the tire radial direction relative to the second virtual profile PR2 in the same manner as described above. The recess amount (maximum value) from the second virtual profile PR2 at the inner end portion of the center land portion 20C in the vehicle width direction is defined as CR2. As illustrated in FIG. 6, in the meridian cross-sectional view, both end portions of the center land portion 20C are recessed toward the inner side in the tire radial direction, so that the center land portion 20C has a convex shape.

As illustrated in FIG. 6, the outer end portion of the second middle land portion 20Mb in the vehicle width direction is also recessed toward the inner side in the tire radial direction relative to the second virtual profile PR2 in the same manner as described above. The recess amount (maximum value) from the second virtual profile PR2 at the outer end portion of the second middle land portion 20Mb in the vehicle width direction is defined as MR3. The inner end portion of the second middle land portion 20Mb in the vehicle width direction is also recessed toward the inner side in the tire radial direction relative to the second virtual profile PR2 in the same manner as described above. The recess amount (maximum value) from the second virtual profile PR2 at the inner end portion of the second middle land portion 20Mb in the vehicle width direction is defined as MR4. As illustrated in FIG. 6, in the meridian cross-sectional view, both end portions of the second middle land portion 20Mb are recessed toward the inner side in the tire radial direction, so that the second middle land portion 20Mb has a convex shape.

As illustrated in FIG. 6, the inner end portion of the shoulder land portion 20Sa in the vehicle width direction is also recessed toward the inner side in the tire radial direction relative to the first virtual profile PR1 in the same manner as described above. The recess amount (maximum value) from the first virtual profile PR1 at the inner end portion of the shoulder land portion 20Sa in the vehicle width direction is defined as SR1. In the meridian cross-sectional view, both end portions of the shoulder land portion 20Sa are recessed toward the inner side in the tire radial direction, so that the shoulder land portion 20Sa has a convex shape.

As illustrated in FIG. 6, the outer end portion of the shoulder land portion 20Sb in the vehicle width direction is also recessed toward the inner side in the tire radial direction relative to the second virtual profile PR2 in the same manner as described above. The recess amount (maximum value) from the second virtual profile PR2 at the outer end portion of the shoulder land portion 20Sb in the vehicle width direction is defined as SR2. In the meridian cross-sectional view, both end portions of the shoulder land portion 20Sb are recessed toward the inner side in the tire radial direction, so that the shoulder land portion 20Sb has a convex shape.

Here, referring to FIG. 6, the recess amount CR1 at the outer end portion of the center land portion 20C in the vehicle width direction is larger than the recess amount MR2 at the inner end portion of the first middle land portion 20Ma in the vehicle width direction. Further, the recess amount CR2 at the inner end portion of the center land portion 20C in the vehicle width direction is larger than the recess amount MR3 at the outer end portion of the second middle land portion 20Mb in the vehicle width direction. By greatly recessing the center land portion 20C in this way, the drainage property of the center land portion, which has the worst drainage property, can be improved. The wet steering stability performance can be improved by an increase in the ground contact pressure, and also the rigidity of the land portion does not decrease, so that the dry steering stability performance can be maintained. As another countermeasure, it is conceivable to increase the groove area of the lug groove to increase the ground contact pressure. However, this is not preferable because the rigidity of the land portion decreases and the dry steering stability performance is deteriorated. The recess amount MR1 at the outer end portion of the first middle land portion 20Ma in the vehicle width direction (in other words, the end portion on the shoulder land portion 20Sa side) is preferably equal to or greater than the recess amount SR1 at the inner end portion of the shoulder land portion 20S a in the vehicle width direction (in other words, the end portion on the first middle land portion 20Ma side). Further, the recess amount MR4 at the inner end portion of the second middle land portion 20Mb in the vehicle width direction (in other words, the end portion on the shoulder land portion 20Sb side) is preferably equal to or greater than the recess amount SR2 at the outer end portion of the shoulder land portion 20Sb in the vehicle width direction (that is, the end portion on the second middle land portion 20Mb side).

Returning to FIG. 5, the intersection points of the first virtual profile PR1 and the extension lines KMS1 and KMS2 extended from the groove walls KM1 and KM2 of the first middle land portion 20Ma of the circumferential main grooves 21 and 22 adjacent to both end portions of the first middle land portion 20Ma in the tire width direction are defined as E1 and E2, respectively. Further, the distance in the tire width direction between the intersection point E1 and the intersection point E2 is defined as Wa. At this time, the ground contact edge of the first middle land portion 20Ma is located on a more inner side of the first middle land portion 20Ma in the tire width direction than a position at a distance of 0.03Wa from each of both end portions of the first middle land portion 20Ma. That is, the points B1 and B2 projected onto the first middle land portion 20Ma in the normal direction of the first virtual profile PR1 from the points A1 and A2 moved by the distance of 0.03Wa along the first virtual profile PR1 from the intersection points E1 and E2 toward the center of the first middle land portion 20Ma do not touch the ground.

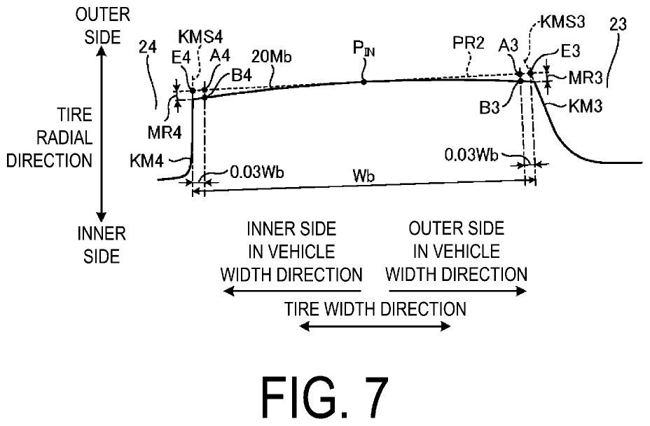

The same applies to the end portions in the tire width direction of the second middle land portion 20Mb described with reference to FIG. 6. That is, as illustrated in FIG. 7, the intersection points of the second virtual profile PR2 and the extension lines KMS3 and KMS4 extended from the groove walls KM3 and KM4 of the second middle land portion 20Mb of the circumferential main grooves 23 and 24 adjacent to both end portions of the second middle land portion 20Mb in the tire width direction are defined as E3 and E4, respectively. Further, the distance in the tire width direction between the intersection point E3 and the intersection point E4 is defined as Wb. At this time, the ground contact edge of the second middle land portion 20Mb is located on a more inner side of the second middle land portion 20Mb in the tire width direction than a position at a distance of 0.03Wb from each of both end portions of the second middle land portion 20Mb. That is, the points B3 and B4 projected onto the second middle land portion 20Mb in the normal direction of the second virtual profile PR2 from the points A3 and A4 moved by the distance of 0.03Wb along the second virtual profile PR2 from the intersection points E3 and E4 toward the center of the second middle land portion 20Mb do not touch the ground.

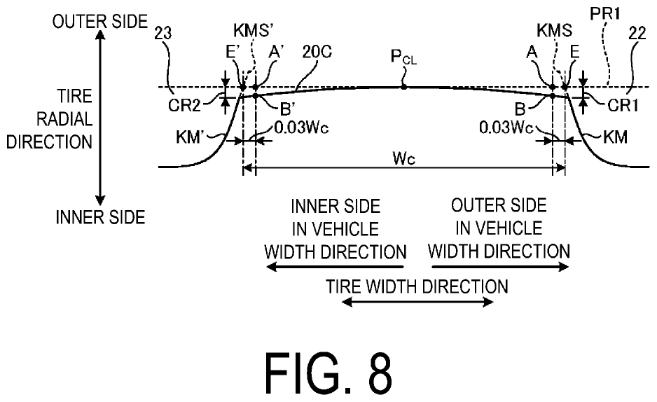

The same applies to the end portions in the tire width direction of the center land portion 20C described with reference to FIG. 6. In other words, as illustrated in FIG. 8, the intersection point of the first virtual profile PR1 and the extension line KMS extended from the groove wall KM on the center land portion 20C side of the circumferential main groove 22 adjacent to the outer end portion of the center land portion 20C in the vehicle width direction is defined as E. Further, the intersection point of the first virtual profile PR1 and the extension line KMS′ extended from the groove wall KM′ on the center land portion 20C side of the circumferential main groove 23 adjacent to the inner end portion of the center land portion 20C in the vehicle width direction is defined as E′. Then, the distance in the tire width direction between the intersection point E and the intersection point E′ is defined as Wc.

At this time, the ground contact edge of the center land portion 20C is located on a more inner side of the center land portion 20C in the tire width direction than a position at a distance of 0.03Wc from each of both end portions of the center land portion 20C. In other words, the point B projected onto the center land portion 20C in the normal direction of the first virtual profile PR1 from the point A moved by the distance of 0.03Wc along the first virtual profile PR1 from the intersection point E toward the center of the center land portion 20C does not touch the ground. Further, the point B′ projected onto the center land portion 20C in the normal direction of the first virtual profile PR1 from the point A′ moved by the distance of 0.03Wc along the first virtual profile PR1 from the intersection point E′ toward the center of the center land portion 20C does not touch the ground.

In the example described with reference to FIG. 8, it is assumed that the first virtual profile PR1 and the second virtual profile PR2 are identical. When the first virtual profile PR1 and the second virtual profile PR2 are different, in FIG. 8, the intersection point of the extension line KMS′ extended from the groove wall KM′ and the second virtual profile PR2 is the intersection point E′.

When the second virtual profile PR2 is used as a reference for the inner side in the vehicle width direction, in FIG. 8, the intersection point of the second virtual profile PR2 and the extension line KMS′ extended from the groove wall KM′ on the center land portion 20C side of the circumferential main groove 23 adjacent to the inner end portion of the center land portion 20C in the vehicle width direction is E′. Then, assuming that the distance in the tire width direction between the intersection point E and the intersection point E′ is Wc′, the point B′ projected onto the center land portion 20C in the normal direction of the second virtual profile PR2 from the point A′ moved by the distance of 0.03Wc′ along the second virtual profile PR2 from the intersection point E′ toward the center of the center land portion 20C does not touch the ground. That is, the ground contact edge of the center land portion 20C is located on a more inner side in the tire width direction than a position at a distance of 0.03Wc′ from the end portion of the center land portion 20C on the middle land portion side. That is, when the second virtual profile PR2 is used as a reference, in FIG. 8, the “distance WC” is replaced with the “distance Wc′” and “0.03Wc” is replaced with “0.03Wc′”.

In FIG. 6, the difference between the recess amount CR1 and the recess amount MR2 is preferably 0.1 mm or more and 0.8 mm or less. The difference between the recess amount CR2 and the recess amount MR3 is preferably 0.1 mm or more and 0.8 mm or less. An excessively small difference in the recess amount is not preferable because the drainage performance of the center land portion 20C deteriorates. The difference in the recess amount is more preferably 0.2 mm or more and 0.8 mm or less. When the difference in the recess amount is within this range, the drainage performance can be further improved. When the difference in the recess amount is too large, the ground contact pressure of the center land portion 20C rises too much and thus the ground contact pressure becomes non-uniform. This is not preferable because the lateral force during steering on a dry road surface, which has a large ground contact area especially when viewed microscopically, is not efficiently transmitted to the road surface, resulting in deterioration of dry steering stability performance.

### Width of Land Portion

In FIG. 6, the width of the center land portion 20C, in other words, the width in the tire width direction is defined as Wc. The width of the first middle land portion 20Ma, in other words, the width in the tire width direction is defined as Wa. The width of the second middle land portion 20Mb, in other words, the width in the tire width direction is defined as Wb. The width We is the distance in the tire width direction between the intersection point E and the intersection point E′. The width Wa is the distance in the tire width direction between the intersection point E1 and the intersection point E2. The width Wb is the distance in the tire width direction between the intersection point E3 and the intersection point E4.

The width We of the center land portion 20C is preferably 105% or more and 120% or less of the widths Wa and Wb of the adjacent first middle land portion 20Ma and second middle land portion 20Mb. In other words, it is preferable that Wc/Wa, which is the ratio of the width We to the width Wa, be 1.05 or more and 1.20 or less. Further, it is preferable that Wc/Wb, which is the ratio of the width We to the width Wb, be 1.05 or more and 1.20 or less. By making the length of the center land portion 20C having a large ground contact length in the tire width direction larger than that of the adjacent land portion, it is possible to secure the dry steering stability performance while maintaining the drainage performance. The ratio Wc/Wa and the ratio Wc/Wb exceeding 1.20 deteriorates the drainage performance and is not preferable.

### Lug Groove

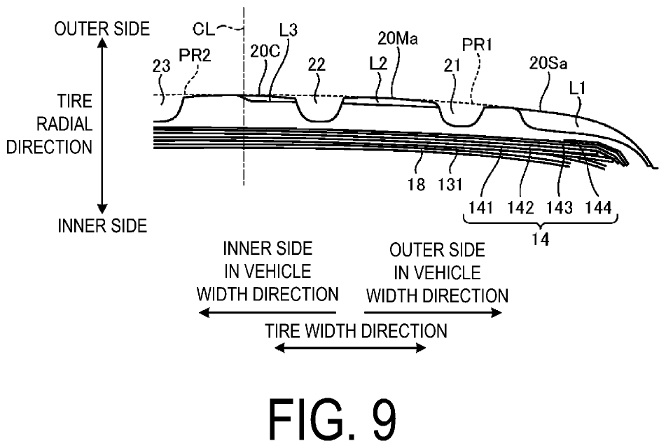

FIG. 9 is an enlarged meridian cross-sectional view of the center land portion 20C, the middle land portion 20Ma, and the shoulder land portion 20Sa. As illustrated in FIG. 9, the shoulder land portion 20Sa is provided with a lug groove L1. The middle land portion 20Ma is provided with a lug groove L2. The center land portion 20C is provided with a lug groove L3. By providing these lug grooves L1, L2 and L3, the drainage performance is improved. Therefore, the wet steering stability performance can be further improved.

Further, it is preferable that the groove opening portions of the lug grooves L1, L2 and L3 be provided with chamfers. In particular, the lug groove L1 of the shoulder land portion 20Sa has a great effect of contributing to drainage performance. Therefore, it is preferable that the groove opening portion of the lug groove L1 be provided with a chamfer.

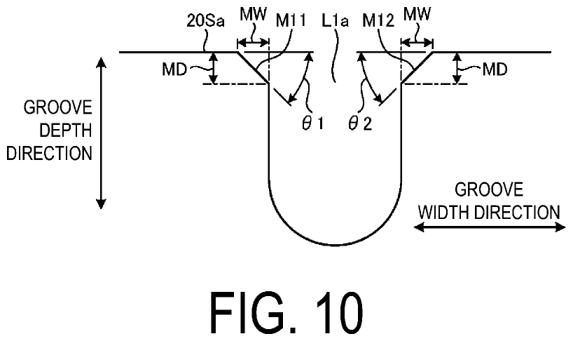

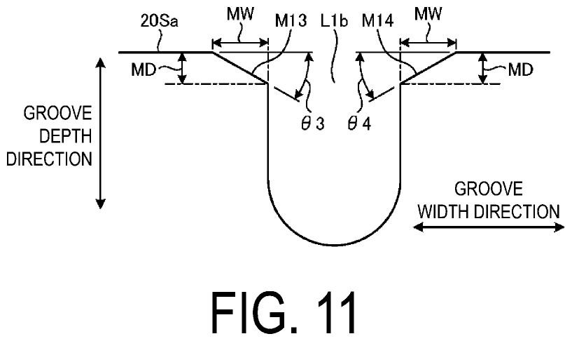

FIGS. 10 and 11 are views illustrating an example of a cross-section of the lug groove of the shoulder land portion 20Sa. As illustrated in FIG. 10, chamfers M11 and M12 are provided at the opening portion of the lug groove L1a. Angles θ1 and θ2 of the chamfers M11 and M12 of the lug groove L1a with respect to the road contact surface of the land portion 20Sa are both 45 degrees. Therefore, a length MD of the chamfers M11 and M12 in the groove depth direction and a length MW of the chamfers M11 and M12 in the groove width direction are identical.

Further, as illustrated in FIG. 11, chamfers M13 and M14 are provided at the opening portion of the lug groove L1b. Angles θ3 and θ4 of the chamfers M13 and M14 of the lug grooves L1b with respect to the road contact surface of the shoulder land portion 20Sa are both, for example, 27 degrees. Therefore, a length MW of the chamfers M13 and M14 in the groove width direction is larger than a length MD of the chamfers M13 and M14 in the groove depth direction. As described above, for the chamfers M13 and M14 of the lug groove L1, the length MW in the groove width direction is set to be larger than the length MD in the groove depth direction, so that the drainage performance can be improved. Therefore, both wet steering stability performance and dry steering stability performance can be achieved in a compatible manner.

### Examples of Contact Patch Shape

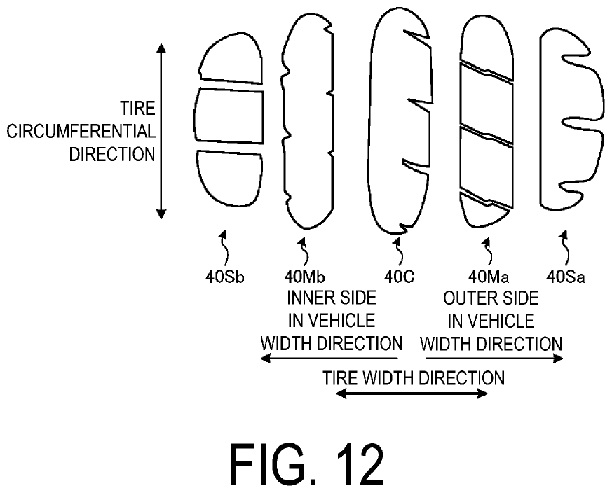

FIG. 12 is a diagram illustrating an example of the contact patch shape of the tire according to the present embodiment. Regions illustrated in FIG. 12 correspond to the respective land portions provided in the tread portion 2 described with reference to FIG. 2. In FIG. 12, a region 40C corresponds to the center land portion 20C in FIG. 2. A region 40Ma corresponds to the first middle land portion 20Ma, and a region 40Mb corresponds to the second middle land portion 20Mb. A region 40Sa corresponds to the first shoulder land portion 20Sa, and a region 40Sb corresponds to the second shoulder land portion 20Sb. As described above, since the recess amounts from the first virtual profile PR1 and the second virtual profile PR2 are appropriately set at the end portions of the respective land portions, the length of the region 40C in the tire circumferential direction is the longest, and the lengths of the regions 40Sa and 40Sb corresponding to the shoulder land portions in the tire circumferential direction are relatively short. Therefore, the balance of each region is good. Therefore, the drainage performance of the portion corresponding to the circumferential main groove can be improved.

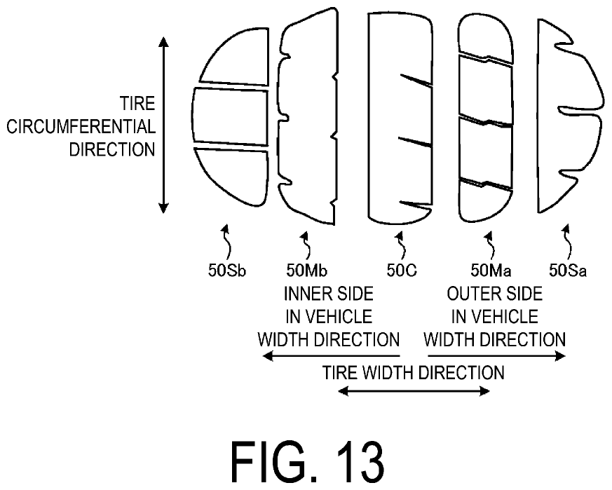

FIG. 13 is a diagram illustrating an example of the contact patch shape of the tire according to a comparative example. FIG. 13 illustrates an example of the contact patch shape when the recess amounts from the first virtual profile PR1 and the second virtual profile PR2 are not appropriately set at the end portions of the respective land portions. FIG. 13 illustrates a region 50C corresponding to the center land portion, a region 50Ma corresponding to the first middle land portion, a region 50Mb corresponding to the second middle land portion, a region 50Sa corresponding to the first shoulder land portion, and a region 50b corresponding to the second shoulder land portion.

Referring to FIG. 13, the area of the portion corresponding to the lug groove in each region is smaller than that in the case of FIG. 12. Therefore, in the case of FIG. 13, it is difficult to improve the drainage performance. Comparing the lengths in the tire circumferential direction of the regions, the length of the region 50C corresponding to the center land portion 20C in the tire circumferential direction is shorter than the length of the region 50Mb corresponding to the second middle land portion 20Mb in the tire circumferential direction. Further, the length of the region 50Sa corresponding to the land portion of the first shoulder in the tire circumferential direction is relatively long. As described above, the balance of the length of each region in the tire circumferential direction is poor. Therefore, it is difficult to improve the dry steering stability performance and the wet steering stability performance.

### SUMMARY

As described above, a structure is employed in which the end portion of the center land portion and the end portion of the middle land portion on both sides of the circumferential main groove are recessed toward the inner side in the tire radial direction relative to the virtual profile, the recess amount of the former end portion is larger than that of the latter end portion, and a range of 0.03Wc (or 0.03Wc′) from the end portion of the center land portion on the middle land portion side does not touch the ground, so that an appropriate contact patch shape of the tire can be obtained. This structure can improve the dry steering stability performance and the wet steering stability performance.

Since the dry steering stability performance and the wet steering stability performance are particularly effective on the outer side in the vehicle width direction, the dry steering stability performance and the wet steering stability performance can be improved by adopting the above-mentioned structure at least on the outer side in the vehicle width direction. Further, by adopting the above-mentioned structure on the inner side in the vehicle width direction, it is possible to improve the dry steering stability performance and the wet steering stability performance.

In the above-mentioned structure, the bulge of the center land portion, which requires drainage performance is made larger than the bulge of the adjacent land portion, and the width of the circumferential main groove adjacent to the center land portion is made relatively wide. As a result, water can be effectively discharged from the land portion to the circumferential main groove. In addition, because of an increase in the amount of bulge, the end portion of the center land portion in the tire width direction does not touch the ground, so that the actual ground contact area decreases, the ground contact pressure increases, and the wet steering stability performance is improved. If the amounts of the bulges of all the land portions are increased, the wet steering stability performance would be enhanced, but the dry steering stability performance would be deteriorated since the ground contact area is too small. According to the above-mentioned structure, the dry steering stability performance and the wet steering stability performance can be improved.

### EXAMPLES

In the present example, tests for dry steering stability performance and wet steering stability performance were performed on a plurality of types of tires of different conditions (see Tables 1 to 6). In these tests, 255/35ZR19 (96Y) 19×9J pneumatic tires were assembled on a specified rim and inflated to an air pressure of 230 kPa. A vehicle was an FR (Front engine-Rear wheel drive) sedan with an engine displacement of 3500 cc. A sensory evaluation of dry steering stability performance and wet steering stability performance was conducted on a test course by a test driver on a predetermined road surface and at a predetermined speed. The evaluation was conducted using index values, with the reference (100) assigned to the tire of Conventional Example, and a larger value means superior performance. When the evaluation value is “95” or higher, the performance required for the tire is secured.

The tires of Examples 1 to 31 include a plurality of circumferential main grooves provided in the tread portion and extending in the tire circumferential direction, and a plurality of land portions defined by the plurality of circumferential main grooves, and, on a vehicle outer side region, there are provided a center land portion closest to a tire equatorial plane, a first shoulder land portion including one ground contact edge of the ground contact edges on both sides in the tire width direction with respect to the tire equatorial plane, and a first middle land portion between the first shoulder land portion and the center land portion. In the tires of Examples 1 to 31, on the vehicle outer side, the end portion of the center land portion on the first middle land portion side is recessed toward the inner side in the tire radial direction relative to the first virtual profile, the end portion of the first middle land portion on the center land portion side is recessed toward the inner side in the tire radial direction relative to the first virtual profile, a recess amount of the end portion of the center land portion on the first middle land portion side is larger than a recess amount of the end portion of the first middle land portion on the center land portion side, and when, in the tire meridian cross-sectional view, the distance between the intersection points of the first virtual profile and the extension lines extended from the groove walls, on the center land portion sides, of the circumferential main grooves adjacent to both end portions of the center land portion in the tire width direction is defined as Wc, the ground contact edge of the center land portion is located on a more inner side than a position at a distance of 0.03Wc from the end portion of the center land portion on the first middle land portion side.

Further, in the tires of Examples 17 to 31, on the vehicle inner side, the end portion of the center land portion on the second middle land portion side is recessed toward the inner side in the tire radial direction relative to the second virtual profile, the end portion of the second middle land portion on the center land portion side is recessed toward the inner side in the tire radial direction relative to the second virtual profile, a recess amount of the end portion of the center land portion on the second middle land portion side is larger than the recess amount of the end portion on the center land portion side of the second middle land portion, and when, in the tire meridian cross-sectional view, the distance between the intersection points of the second virtual profile and the extension lines extended from the groove walls, on the center land portion sides, of the circumferential main grooves adjacent to both end portions of the center land portion in the tire width direction is defined as Wc′, the ground contact edge of the center land portion is located on a more inner side than a position at a distance of 0.03Wc′ from the end portion of the center land portion on the second middle land portion side.

In the tire of Conventional Example, the recess amount from the virtual profile is uniform. In the tire of Comparative Example 1, the recess amount of the end portion of the center land portion on the second middle land portion side is smaller than the recess amount of the end portion of the second middle land portion on the center land portion side. In the tires of Comparative Example 3 and Comparative Example 4, the recess amount of the end portion of the center land portion on the second middle land portion side is identical to the recess amount of the end portion of the second middle land portion on the center land portion side. In the tire of Comparative Example 2, the ground contact edge of the center land portion is located on a more outer side than a position at a distance of 0.03Wc from the end portion of the center land portion on the first middle land portion side. When the recess amount in Table 1 is a negative value, it indicates the projection amount.

According to the tires of Examples 1 to 31, it can be seen that satisfactory results are obtained when, at least on the vehicle outer side, the end portion of the center land portion on the first middle land portion side is recessed toward the inner side in the tire radial direction relative to the first virtual profile, the end portion of the first middle land portion on the center land portion side is recessed toward the inner side in the tire radial direction relative to the first virtual profile, the recess amount of the end portion of the center land portion on the first middle land portion side is larger than the recess amount of the end portion of the first middle land portion on the center land portion side, and when, in the meridian cross-sectional view, the distance between the intersection points of the first virtual profile and the extension lines extended from the groove walls, on the center land portion sides, of the circumferential main grooves adjacent to both end portions of the center land portion in the tire width direction is defined as Wc, the ground contact edge of the center land portion is located on a more inner side than a position at a distance of 0.03Wc from the end portion of the center land portion on the first middle land portion side.

Further, according to the tires of Examples 17 to 31, it can be seen that satisfactory results are obtained when, on the vehicle inner side, the end portion of the center land portion on the second middle land portion side is recessed toward the inner side in the tire radial direction relative to the second virtual profile, the end portion of the second middle land portion on the center land portion side is recessed toward the inner side in the tire radial direction relative to the second virtual profile, the recess amount of the end portion of the center land portion on the second middle land portion side is larger than the recess amount of the end portion of the second middle land portion on the center land portion side, and when, in the tire meridian cross-sectional view, the distance between the intersection points of the second virtual profile and the extension lines extended from the groove walls, on the center land portion sides, of the circumferential main grooves adjacent to both end portions of the center land portion in the tire width direction is defined as Wc′, the ground contact edge of the center land portion is located on a more inner side than a position at a distance of 0.03Wc′ from the end portion of the center land portion on the second middle land portion side.

TABLE 1

| | | Conventional | | Comparative | Comparative |
|---|---|---|---|---|---|
| | | Example | Example 1 | Example 1 | Example 2 |
| Outer | Maximum recess amount | 0.2 | 0.7 | 0.4 | 0.7 |
| side in | CR1 [mm] of middle-land- | | | | |
| vehicle | portion-side end portion of | | | | |
| width | center land portion | | | | |
| direction | Maximum recess amount | 0.2 | 0.4 | 0.7 | 0.4 |
| | MR2 [mm] of center-land- | | | | |
| | portion-side end portion of | | | | |
| | middle land portion | | | | |
| | Difference (CR1 − MR2) [mm] | 0 | 0.3 | −0.3 | 0.3 |
| | Maximum recess amount | 0.2 | 0.4 | 0.7 | 0.4 |
| | MR1 [mm] of shoulder-land- | | | | |
| | portion-side end portion of | | | | |
| | middle land portion | | | | |
| | Maximum recess amount SR1 | 0.2 | 0.4 | 0.7 | 0.4 |
| | [mm] of middle-land-portion- | | | | |
| | side end portion of shoulder | | | | |
| | land portion | | | | |
| | Difference (MR1 − SR1) [mm] | 0 | 0 | 0 | 0 |
| | Ground contact edge of | Outer side | Inner side | Inner side | Outer side |
| | center land portion is on | | | | |
| | inner side or outer side of | | | | |
| | 0.03 W | | | | |
| | Ground contact edge of | Outer side | Inner side | Inner side | Outer side |
| | middle land portion is on | | | | |
| | inner side or outer side of | | | | |
| | 0.03 W | | | | |
| | Adjacent groove width of | 110 | 110 | 110 | 110 |
| | center land portion/shoulder | | | | |
| | groove width [%] | | | | |
| | Center land portion width | 110 | 110 | 110 | 110 |
| | Wc/middle land portion | | | | |
| | width Wa [%] | | | | |
| | Chamfer width MW of | 200 | 200 | 200 | 200 |
| | shoulder lug groove/chamfer | | | | |
| | depth MD [%] | | | | |
| Inner | Maximum recess amount | 0.2 | 0.7 | 0.4 | 0.7 |
| side in | CR2 [mm] of middle-land- | | | | |
| vehicle | portion-side end portion of | | | | |
| width | center land portion | | | | |
| direction | Maximum recess amount | 0.2 | 0.4 | 0.7 | 0.4 |
| | MR3 [mm] of center-land- | | | | |
| | portion-side end portion of | | | | |
| | middle land portion | | | | |
| | Difference (CR2 − MR3) [mm] | 0 | 0.3 | −0.3 | 0.3 |
| | Recess amount MR4 [mm] of | 0.2 | 0.4 | 0.4 | 0.4 |
| | shoulder-land-portion-side | | | | |
| | end portion of middle land | | | | |
| | portion | | | | |
| | Maximum recess amount SR2 | 0.2 | 0.4 | 0.4 | 0.4 |
| | [mm] of middle-land-portion- | | | | |
| | side end portion of shoulder | | | | |
| | land portion | | | | |
| | Difference (MR4 − SR2) [mm] | 0 | 0 | 0 | 0 |
| | Ground contact edge of | Outer side | Inner side | Inner side | Inner side |
| | center land portion is on | | | | |
| | inner side or outer side of | | | | |
| | 0.03 W | | | | |
| | Ground contact edge of | Outer side | Inner side | Inner side | Inner side |
| | middle land portion is on | | | | |
| | inner side or outer side of | | | | |
| | 0.03 W | | | | |
| | Adjacent groove width of | 110 | 110 | 110 | 110 |
| | center land portion/shoulder | | | | |
| | groove width [%] | | | | |
| | Center land portion width | 110 | 110 | 110 | 110 |
| | Wc/middle land portion | | | | |
| | width Wb [%] | | | | |
| | Chamfer width MW of | 200 | 200 | 200 | 200 |
| | shoulder lug groove/chamfer | | | | |
| | depth MD [%] | | | | |

| | | | | |
|---|---|---|---|---|
| Tread rubber hardness | 75 | 75 | 75 | 75 |
| Dry steering stability performance | 100 | 100 | 100 | 100 |
| Wet steering stability performance | 100 | 120 | 100 | 100 |

| | | Comparative | Comparative | |
|---|---|---|---|---|
| | | Example 3 | Example 4 | Example 2 |
| Outer | Maximum recess amount | 0.4 | 1.5 | 0.5 |
| side in | CR1 [mm] of middle-land- | | | |
| vehicle | portion-side end portion of | | | |
| width | center land portion | | | |
| direction | Maximum recess amount | 0.4 | 1.5 | 0.4 |
| | MR2 [mm] of center-land- | | | |
| | portion-side end portion of | | | |
| | middle land portion | | | |
| | Difference (CR1 − MR2) [mm] | 0 | 0 | 0.1 |
| | Maximum recess amount | 0.4 | 1.5 | 0.4 |
| | MR1 [mm] of shoulder-land- | | | |
| | portion-side end portion of | | | |
| | middle land portion | | | |
| | Maximum recess amount SR1 | 0.4 | 1.5 | 0.4 |
| | [mm] of middle-land-portion- | | | |
| | side end portion of shoulder | | | |
| | land portion | | | |
| | Difference (MR1 − SR1) [mm] | 0 | 0 | 0 |
| | Ground contact edge of | Inner side | Inner side | Inner side |
| | center land portion is on | | | |
| | inner side or outer side of | | | |
| | 0.03 W | | | |
| | Ground contact edge of | Inner side | Inner side | Inner side |
| | middle land portion is on | | | |
| | inner side or outer side of | | | |
| | 0.03 W | | | |
| | Adjacent groove width of | 110 | 110 | 110 |
| | center land portion/shoulder | | | |
| | groove width [%] | | | |
| | Center land portion width | 110 | 110 | 110 |
| | Wc/middle land portion | | | |
| | width Wa [%] | | | |
| | Chamfer width MW of | 200 | 200 | 200 |
| | shoulder lug groove/chamfer | | | |
| | depth MD [%] | | | |
| Inner | Maximum recess amount | 0.4 | 1.5 | 0.5 |
| side in | CR2 [mm] of middle-land- | | | |
| vehicle | portion-side end portion of | | | |
| width | center land portion | | | |
| direction | Maximum recess amount | 0.4 | 1.5 | 0.4 |
| | MR3 [mm] of center-land- | | | |
| | portion-side end portion of | | | |
| | middle land portion | | | |
| | Difference (CR2 − MR3) [mm] | 0 | 0 | 0.1 |
| | Recess amount MR4 [mm] of | 0.4 | 0.4 | 0.4 |
| | shoulder-land-portion-side | | | |
| | end portion of middle land | | | |
| | portion | | | |
| | Maximum recess amount SR2 | 0.4 | 0.4 | 0.4 |
| | [mm] of middle-land-portion- | | | |
| | side end portion of shoulder | | | |
| | land portion | | | |
| | Difference (MR4 − SR2) [mm] | 0 | 0 | 0 |
| | Ground contact edge of | Inner side | Inner side | Inner side |
| | center land portion is on | | | |
| | inner side or outer side of | | | |
| | 0.03 W | | | |
| | Ground contact edge of | Inner side | Inner side | Inner side |
| | middle land portion is on | | | |
| | inner side or outer side of | | | |
| | 0.03 W | | | |
| | Adjacent groove width of | 110 | 110 | 110 |
| | center land portion/shoulder | | | |
| | groove width [%] | | | |
| | Center land portion width | 110 | 110 | 110 |
| | Wc/middle land portion | | | |
| | width Wb [%] | | | |
| | Chamfer width MW of | 200 | 200 | 200 |
| | shoulder lug groove/chamfer | | | |
| | depth MD [%] | | | |

| | | | |
|---|---|---|---|
| Tread rubber hardness | 75 | 75 | 75 |
| Dry steering stability performance | 100 | 90 | 100 |
| Wet steering stability performance | 100 | 120 | 110 |

TABLE 2

| | | Example 3 | Example 4 | Example 5 |
|---|---|---|---|---|
| Outer | Maximum recess amount CR1 [mm] | 0.6 | 1.2 | 1.3 |
| side in | of middle-land-portion-side end | | | |
| vehicle | portion of center land portion | | | |
| width | Maximum recess amount MR2 [mm] | 0.4 | 0.4 | 0.4 |
| direction | of center-land-portion-side end | | | |
| | portion of middle land portion | | | |
| | Difference (CR1 − MR2) [mm] | 0.2 | 0.8 | 0.9 |
| | Maximum recess amount MR1 [mm] | 0.4 | 0.4 | 0.4 |
| | of shoulder-land-portion-side end | | | |
| | portion of middle land portion | | | |
| | Maximum recess amount SR1 [mm] | 0.4 | 0.4 | 0.4 |
| | of middle-land-portion-side end | | | |
| | portion of shoulder land portion | | | |
| | Difference (MR1 − SR1) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center | 110 | 110 | 110 |
| | land portion/shoulder groove width | | | |
| | [%] | | | |
| | Center land portion width Wc/ | 110 | 110 | 110 |
| | middle land portion width Wa [%] | | | |
| | Chamfer width MW of shoulder lug | 200 | 200 | 200 |
| | groove/chamfer depth MD [%] | | | |
| Inner | Maximum recess amount CR2 [mm] | 0.6 | 1.2 | 1.3 |
| side in | of middle-land-portion-side end | | | |
| vehicle | portion of center land portion | | | |
| width | Maximum recess amount MR3 [mm] | 0.4 | 0.4 | 0.4 |
| direction | of center-land-portion-side end | | | |
| | portion of middle land portion | | | |
| | Difference (CR2 − MR3) [mm] | 0.2 | 0.8 | 0.9 |
| | Recess amount MR4 [mm] of | 0.4 | 0.4 | 0.4 |
| | shoulder-land-portion-side end | | | |
| | portion of middle land portion | | | |
| | Maximum recess amount SR2 [mm] | 0.4 | 0.4 | 0.4 |
| | of middle-land-portion-side end | | | |
| | portion of shoulder land portion | | | |
| | Difference (MR4 − SR2) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center | 110 | 110 | 110 |
| | land portion/shoulder groove width | | | |
| | [%] | | | |
| | Center land portion width Wc/ | 110 | 110 | 110 |
| | middle land portion width Wb [%] | | | |
| | Chamfer width MW of shoulder lug | 200 | 200 | 200 |
| | groove/chamfer depth MD [%] | | | |
| Tread rubber hardness | | 75 | 75 | 75 |
| Dry steering stability performance | | 100 | 100 | 95 |
| Wet steering stability performance | | 120 | 125 | 125 |
| | | Example 6 | Example 7 | Example 8 |
| Outer | Maximum recess amount CR1 [mm] | 0.7 | 0.7 | 0.7 |
| side in | of middle-land-portion-side end | | | |
| vehicle | portion of center land portion | | | |
| width | Maximum recess amount MR2 [mm] | 0.4 | 0.4 | 0.4 |
| direction | of center-land-portion-side end | | | |
| | portion of middle land portion | | | |
| | Difference (CR1 − MR2) [mm] | 0.3 | 0.3 | 0.3 |
| | Maximum recess amount MR1 [mm] | 0.4 | 0.4 | 0.4 |
| | of shoulder-land-portion-side end | | | |
| | portion of middle land portion | | | |
| | Maximum recess amount SR1 [mm] | 0.4 | 0.4 | 0.4 |
| | of middle-land-portion-side end | | | |
| | portion of shoulder land portion | | | |
| | Difference (MR1 − SR1) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center | 100 | 102 | 110 |
| | land portion/shoulder groove width | | | |
| | [%] | | | |
| | Center land portion width Wc/ | 110 | 110 | 103 |
| | middle land portion width Wa [%] | | | |
| | Chamfer width MW of shoulder lug | 200 | 200 | 200 |
| | groove/chamfer depth MD [%] | | | |
| Inner | Maximum recess amount CR2 [mm] | 0.7 | 0.7 | 0.7 |
| side in | of middle-land-portion-side end | | | |
| vehicle | portion of center land portion | | | |
| width | Maximum recess amount MR3 [mm] | 0.4 | 0.4 | 0.4 |
| direction | of center-land-portion-side end | | | |
| | portion of middle land portion | | | |
| | Difference (CR2 − MR3) [mm] | 0.3 | 0.3 | 0.3 |
| | Recess amount MR4 [mm] of | 0.4 | 0.4 | 0.4 |
| | shoulder-land-portion-side end | | | |
| | portion of middle land portion | | | |
| | Maximum recess amount SR2 [mm] | 0.4 | 0.4 | 0.4 |
| | of middle-land-portion-side end | | | |
| | portion of shoulder land portion | | | |
| | Difference (MR4 − SR2) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center | 110 | 110 | 110 |
| | land portion/shoulder groove width | | | |
| | [%] | | | |
| | Center land portion width Wc/ | 110 | 110 | 110 |
| | middle land portion width Wb [%] | | | |
| | Chamfer width MW of shoulder lug | 200 | 200 | 200 |
| | groove/chamfer depth MD [%] | | | |

| | | | |
|---|---|---|---|
| Tread rubber hardness | 75 | 75 | 75 |
| Dry steering stability performance | 100 | 100 | 100 |
| Wet steering stability performance | 110 | 115 | 110 |

TABLE 3

| | | Example 9 | Example 10 | Example 11 |
|---|---|---|---|---|
| Outer | Maximum recess amount CR1 [mm] | 0.7 | 0.7 | 0.7 |
| side in | of middle-land-portion-side end | | | |
| vehicle | portion of center land portion | | | |
| width | Maximum recess amount MR2 [mm] | 0.4 | 0.4 | 0.4 |
| direction | of center-land-portion-side end | | | |
| | portion of middle land portion | | | |
| | Difference (CR1 − MR2) [mm] | 0.3 | 0.3 | 0.3 |
| | Maximum recess amount MR1 [mm] | 0.4 | 0.4 | 0.4 |
| | of shoulder-land-portion-side end | | | |
| | portion of middle land portion | | | |
| | Maximum recess amount SR1 [mm] | 0.4 | 0.4 | 0.4 |
| | of middle-land-portion-side end | | | |
| | portion of shoulder land portion | | | |
| | Difference (MR1 − SR1) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center land | 110 | 110 | 110 |
| | portion/shoulder groove width [%] | | | |
| | Center land portion width Wc/middle | 105 | 120 | 122 |
| | land portion width Wa [%] | | | |
| | Chamfer width MW of shoulder lug | 200 | 200 | 200 |
| | groove/chamfer depth MD [%] | | | |
| Inner | Maximum recess amount CR2 [mm] | 0.7 | 0.7 | 0.7 |
| side in | of middle-land-portion-side end | | | |
| vehicle | portion of center land portion | | | |
| width | Maximum recess amount MR3 [mm] | 0.4 | 0.4 | 0.4 |
| direction | of center-land-portion-side end | | | |
| | portion of middle land portion | | | |
| | Difference (CR2 − MR3) [mm] | 0.3 | 0.3 | 0.3 |
| | Recess amount MR4 [mm] of | 0.4 | 0.4 | 0.4 |
| | shoulder-land-portion-side end | | | |
| | portion of middle land portion | | | |
| | Maximum recess amount SR2 [mm] | 0.4 | 0.4 | 0.4 |
| | of middle-land-portion-side end | | | |
| | portion of shoulder land portion | | | |
| | Difference (MR4 − SR2) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center land | 110 | 110 | 110 |
| | portion/shoulder groove width [%] | | | |
| | Center land portion width Wc/middle | 110 | 110 | 110 |
| | land portion width Wb [%] | | | |
| | Chamfer width MW of shoulder lug | 200 | 200 | 200 |
| | groove/chamfer depth MD [%] | | | |

| | | | |
|---|---|---|---|
| Tread rubber hardness | 75 | 75 | 75 |
| Dry steering stability performance | 100 | 100 | 100 |
| Wet steering stability performance | 120 | 120 | 110 |

| | | Example 12 | Example 13 | Example 14 |
|---|---|---|---|---|
| Outer | Maximum recess amount CR1 [mm] | 0.7 | 0.7 | 0.7 |
| side in | of middle-land-portion-side end | | | |
| vehicle | portion of center land portion | | | |
| width | Maximum recess amount MR2 [mm] | 0.4 | 0.4 | 0.4 |
| direction | of center-land-portion-side end | | | |
| | portion of middle land portion | | | |
| | Difference (CR1 − MR2) [mm] | 0.3 | 0.3 | 0.3 |
| | Maximum recess amount MR1 [mm] | 0.4 | 0.4 | 0.4 |
| | of shoulder-land-portion-side end | | | |
| | portion of middle land portion | | | |
| | Maximum recess amount SR1 [mm] | 0.4 | 0.4 | 0 |
| | of middle-land-portion-side end | | | |
| | portion of shoulder land portion | | | |
| | Difference (MR1 − SR1) [mm] | 0 | 0 | 0.4 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center land | 110 | 110 | 110 |
| | portion/shoulder groove width [%] | | | |
| | Center land portion width Wc/middle | 110 | 110 | 110 |
| | land portion width Wa [%] | | | |
| | Chamfer width MW of shoulder lug | 200 | 200 | 200 |
| | groove/chamfer depth MD [%] | | | |
| Inner | Maximum recess amount CR2 [mm] | 0.7 | 0.7 | 0.7 |
| side in | of middle-land-portion-side end | | | |
| vehicle | portion of center land portion | | | |
| width | Maximum recess amount MR3 [mm] | 0.4 | 0.4 | 0.4 |
| direction | of center-land-portion-side end | | | |
| | portion of middle land portion | | | |
| | Difference (CR2 − MR3) [mm] | 0.3 | 0.3 | 0.3 |
| | Recess amount MR4 [mm] of | 0.4 | 0.4 | 0.4 |
| | shoulder-land-portion-side end | | | |
| | portion of middle land portion | | | |
| | Maximum recess amount SR2 [mm] | 0.4 | 0.4 | 0.4 |
| | of middle-land-portion-side end | | | |
| | portion of shoulder land portion | | | |
| | Difference (MR4 − SR2) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center land | 110 | 110 | 110 |
| | portion/shoulder groove width [%] | | | |
| | Center land portion width Wc/middle | 110 | 110 | 110 |
| | land portion width Wb [%] | | | |
| | Chamfer width MW of shoulder lug | 200 | 200 | 200 |
| | groove/chamfer depth MD [%] | | | |

| | | | |
|---|---|---|---|
| Tread rubber hardness | 63 | 65 | 75 |
| Dry steering stability performance | 100 | 100 | 100 |
| Wet steering stability performance | 110 | 118 | 115 |

TABLE 4

| | | Example 15 | Example 16 | Example 17 |
|---|---|---|---|---|
| Outer | Maximum recess amount CR1 [mm] | 0.7 | 0.7 | 0.7 |
| side in | of middle-land-portion-side end | | | |
| vehicle | portion of center land portion | | | |
| width | Maximum recess amount MR2 [mm] | 0.4 | 0.4 | 0.4 |
| direction | of center-land-portion-side end | | | |
| | portion of middle land portion | | | |
| | Difference (CR1 − MR2) [mm] | 0.3 | 0.3 | 0.3 |
| | Maximum recess amount MR1 [mm] | 0.4 | 0.4 | 0.4 |
| | of shoulder-land-portion-side end | | | |
| | portion of middle land portion | | | |
| | Maximum recess amount SR1 [mm] | 0.4 | 0.4 | 0.4 |
| | of middle-land-portion-side end | | | |
| | portion of shoulder land portion | | | |
| | Difference (MR1 − SR1) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center land | 110 | 110 | 110 |
| | portion/shoulder groove width [%] | | | |
| | Center land portion width Wc/middle | 110 | 110 | 110 |
| | land portion width Wa [%] | | | |
| | Chamfer width MW of shoulder lug | 100 | 150 | 200 |
| | groove/chamfer depth MD [%] | | | |
| Inner | Maximum recess amount CR2 [mm] | 0.7 | 0.7 | 0.4 |
| side in | of middle-land-portion-side end | | | |
| vehicle | portion of center land portion | | | |
| width | Maximum recess amount MR3 [mm] | 0.4 | 0.4 | 0.7 |
| direction | of center-land-portion-side end | | | |
| | portion of middle land portion | | | |
| | Difference (CR2 − MR3) [mm] | 0.3 | 0.3 | −0.3 |
| | Recess amount MR4 [mm] of | 0.4 | 0.4 | 0.7 |
| | shoulder-land-portion-side end | | | |
| | portion of middle land portion | | | |
| | Maximum recess amount SR2 [mm] | 0.4 | 0.4 | 0.7 |
| | of middle-land-portion-side end | | | |
| | portion of shoulder land portion | | | |
| | Difference (MR4 − SR2) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center land | 110 | 110 | 110 |
| | portion/shoulder groove width [%] | | | |
| | Center land portion width Wc/middle | 110 | 110 | 110 |
| | land portion width Wb [%] | | | |
| | Chamfer width MW of shoulder lug | 200 | 200 | 200 |
| | groove/chamfer depth MD [%] | | | |
| Tread rubber hardness | | 75 | 75 | 75 |
| Dry steering stability performance | | 100 | 100 | 100 |
| Wet steering stability performance | | 115 | 118 | 118 |
| | | Example 18 | Example 19 | Example 20 |
| Outer | Maximum recess amount CR1 [mm] | 0.7 | 0.7 | 0.7 |
| side in | of middle-land-portion-side end | | | |
| vehicle | portion of center land portion | | | |
| width | Maximum recess amount MR2 [mm] | 0.4 | 0.4 | 0.4 |
| direction | of center-land-portion-side end | | | |
| | portion of middle land portion | | | |
| | Difference (CR1 − MR2) [mm] | 0.3 | 0.3 | 0.3 |
| | Maximum recess amount MR1 [mm] | 0.4 | 0.4 | 0.4 |
| | of shoulder-land-portion-side end | | | |
| | portion of middle land portion | | | |
| | Maximum recess amount SR1 [mm] | 0.4 | 0.4 | 0.4 |
| | of middle-land-portion-side end | | | |
| | portion of shoulder land portion | | | |
| | Difference (MR1 − SR1) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center land | 110 | 110 | 110 |
| | portion/shoulder groove width [%] | | | |
| | Center land portion width Wc/middle | 110 | 110 | 110 |
| | land portion width Wa [%] | | | |
| | Chamfer width MW of shoulder lug | 200 | 200 | 200 |
| | groove/chamfer depth MD [%] | | | |
| Inner | Maximum recess amount CR2 [mm] | 0.7 | 0.4 | 1.5 |
| side in | of middle-land-portion-side end | | | |
| vehicle | portion of center land portion | | | |
| width | Maximum recess amount MR3 [mm] | 0.4 | 0.4 | 1.5 |
| direction | of center-land-portion-side end | | | |
| | portion of middle land portion | | | |
| | Difference (CR2 − MR3) [mm] | 0.3 | 0 | 0 |
| | Recess amount MR4 [mm] of | 0.4 | 0.4 | 1.5 |
| | shoulder-land-portion-side end | | | |
| | portion of middle land portion | | | |
| | Maximum recess amount SR2 [mm] | 0.4 | 0.4 | 1.5 |
| | of middle-land-portion-side end | | | |
| | portion of shoulder land portion | | | |
| | Difference (MR4 − SR2) [mm] | 0 | 0 | 0 |
| | Ground contact edge of center land | Outer side | Inner side | Inner side |
| | portion is on inner side or outer side | | | |
| | of 0.03 W | | | |
| | Ground contact edge of middle land | Outer side | Inner side | Inner side |
| | portion is on inner side or outer side | | | |
| | of 0.03 W | | | |
| | Adjacent groove width of center land | 110 | 110 | 110 |
| | portion/shoulder groove width [%] | | | |
| | Center land portion width Wc/middle | 110 | 110 | 110 |
| | land portion width Wb [%] | | | |
| | Chamfer width MW of shoulder lug | 200 | 200 | 200 |
| | groove/chamfer depth MD [%] | | | |

| | | | |
|---|---|---|---|
| Tread rubber hardness | 75 | 75 | 75 |
| Dry steering stability performance | 100 | 100 | 99 |
| Wet steering stability performance | 118 | 118 | 120 |

TABLE 5

| | | Example 21 | Example 22 | Example 23 |
|---|---|---|---|---|
| Outer | Maximum recess amount CR1 [mm] | 0.7 | 0.7 | 0.7 |
| side in | of middle-land-portion-side end | | | |
| vehicle | portion of center land portion | | | |
| width | Maximum recess amount MR2 [mm] | 0.4 | 0.4 | 0.4 |
| direction | of center-land-portion-side end | | | |
| | portion of middle land portion | | | |
| | Difference (CR1 − MR2) [mm] | 0.3 | 0.3 | 0.3 |
| | Maximum recess amount MR1 [mm] | 0.4 | 0.4 | 0.4 |
| | of shoulder-land-portion-side end | | | |
| | portion of middle land portion | | | |
| | Maximum recess amount SR1 [mm] | 0.4 | 0.4 | 0.4 |
| | of middle-land-portion-side end | | | |
| | portion of shoulder land portion | | | |
| | Difference (MR1 − SR1) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center land | 110 | 110 | 110 |
| | portion/shoulder groove width [%] | | | |
| | Center land portion width Wc/middle | 110 | 110 | 110 |
| | land portion width Wa [%] | | | |
| | Chamfer width MW of shoulder lug | 200 | 200 | 200 |
| | groove/chamfer depth MD [%] | | | |
| Inner | Maximum recess amount CR2 [mm] | 0.5 | 0.6 | 1.2 |
| side in | of middle-land-portion-side end | | | |
| vehicle | portion of center land portion | | | |
| width | Maximum recess amount MR3 [mm] | 0.4 | 0.4 | 0.4 |
| direction | of center-land-portion-side end | | | |
| | portion of middle land portion | | | |
| | Difference (CR2 − MR3) [mm] | 0.1 | 0.2 | 0.8 |
| | Recess amount MR4 [mm] of | 0.4 | 0.4 | 0.4 |
| | shoulder-land-portion-side end | | | |
| | portion of middle land portion | | | |
| | Maximum recess amount SR2 [mm] | 0.4 | 0.4 | 0.4 |
| | of middle-land-portion-side end | | | |
| | portion of shoulder land portion | | | |
| | Difference (MR4 − SR2) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center land | 110 | 110 | 110 |
| | portion/shoulder groove width [%] | | | |
| | Center land portion width Wc/middle | 110 | 110 | 110 |
| | land portion width Wb [%] | | | |
| | Chamfer width MW of shoulder lug | 200 | 200 | 200 |
| | groove/chamfer depth MD [%] | | | |
| Tread rubber hardness | | 75 | 75 | 75 |
| Dry steering stability performance | | 100 | 100 | 100 |
| Wet steering stability performance | | 119 | 120 | 121 |
| | | Example 24 | Example 25 | Example 26 |
| Outer | Maximum recess amount CR1 [mm] | 0.7 | 0.7 | 0.7 |
| side in | of middle-land-portion-side end | | | |
| vehicle | portion of center land portion | | | |
| width | Maximum recess amount MR2 [mm] | 0.4 | 0.4 | 0.4 |
| direction | of center-land-portion-side end | | | |
| | portion of middle land portion | | | |
| | Difference (CR1 − MR2) [mm] | 0.3 | 0.3 | 0.3 |
| | Maximum recess amount MR1 [mm] | 0.4 | 0.4 | 0.4 |
| | of shoulder-land-portion-side end | | | |
| | portion of middle land portion | | | |
| | Maximum recess amount SR1 [mm] | 0.4 | 0.4 | 0.4 |
| | of middle-land-portion-side end | | | |
| | portion of shoulder land portion | | | |
| | Difference (MR1 − SR1) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center land | 110 | 110 | 110 |
| | portion/shoulder groove width [%] | | | |
| | Center land portion width Wc/middle | 110 | 110 | 110 |
| | land portion width Wa [%] | | | |
| | Chamfer width MW of shoulder lug | 200 | 200 | 200 |
| | groove/chamfer depth MD [%] | | | |
| Inner | Maximum recess amount CR2 [mm] | 1.3 | 0.7 | 0.7 |
| side in | of middle-land-portion-side end | | | |
| vehicle | portion of center land portion | | | |
| width | Maximum recess amount MR3 [mm] | 0.4 | 0.4 | 0.4 |
| direction | of center-land-portion-side end | | | |
| | portion of middle land portion | | | |
| | Difference (CR2 − MR3) [mm] | 0.9 | 0.3 | 0.3 |
| | Recess amount MR4 [mm] of | 0.4 | 0.4 | 0.4 |
| | shoulder-land-portion-side end | | | |
| | portion of middle land portion | | | |
| | Maximum recess amount SR2 [mm] | 0.4 | 0.4 | 0.4 |
| | of middle-land-portion-side end | | | |
| | portion of shoulder land portion | | | |
| | Difference (MR4 − SR2) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center land | 110 | 100 | 102 |
| | portion/shoulder groove width [%] | | | |
| | Center land portion width Wc/middle | 110 | 110 | 110 |
| | land portion width Wb [%] | | | |
| | Chamfer width MW of shoulder lug | 200 | 200 | 200 |
| | groove/chamfer depth MD [%] | | | |

| | | | |
|---|---|---|---|
| Tread rubber hardness | 75 | 75 | 75 |
| Dry steering stability performance | 100 | 100 | 100 |
| Wet steering stability performance | 121 | 119 | 120 |

TABLE 6

| | | Example 27 | Example 28 | Example 29 |
|---|---|---|---|---|
| Outer | Maximum recess amount CR1 [mm] | 0.7 | 0.7 | 0.7 |
| side in | of middle-land-portion-side end | | | |
| vehicle | portion of center land portion | | | |
| width | Maximum recess amount MR2 [mm] | 0.4 | 0.4 | 0.4 |
| direction | of center-land-portion-side end | | | |
| | portion of middle land portion | | | |
| | Difference (CR1 − MR2) [mm] | 0.3 | 0.3 | 0.3 |
| | Maximum recess amount MR1 [mm] | 0.4 | 0.4 | 0.4 |
| | of shoulder-land-portion-side end | | | |
| | portion of middle land portion | | | |
| | Maximum recess amount SR1 [mm] | 0.4 | 0.4 | 0.4 |
| | of middle-land-portion-side end | | | |
| | portion of shoulder land portion | | | |
| | Difference (MR1 − SR1) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center land | 110 | 110 | 110 |
| | portion/shoulder groove width [%] | | | |
| | Center land portion width Wc/middle | 110 | 110 | 110 |
| | land portion width Wa [%] | | | |
| | Chamfer width MW of shoulder lug | 200 | 200 | 200 |
| | groove/chamfer depth MD [%] | | | |
| Inner | Maximum recess amount CR2 [mm] | 0.7 | 0.7 | 0.7 |
| side in | of middle-land-portion-side end | | | |
| vehicle | portion of center land portion | | | |
| width | Maximum recess amount MR3 [mm] | 0.4 | 0.4 | 0.4 |
| direction | of center-land-portion-side end | | | |
| | portion of middle land portion | | | |
| | Difference (CR2 − MR3) [mm] | 0.3 | 0.3 | 0.3 |
| | Recess amount MR4 [mm] of | 0.4 | 0.4 | 0.4 |
| | shoulder-land-portion-side end | | | |
| | portion of middle land portion | | | |
| | Maximum recess amount SR2 [mm] | 0.4 | 0.4 | 0.4 |
| | of middle-land-portion-side end | | | |
| | portion of shoulder land portion | | | |
| | Difference (MR4 − SR2) [mm] | 0 | 0 | 0 |
| | Ground contact edge of center land | Inner side | Inner side | Inner side |
| | portion is on inner side or outer side | | | |
| | of 0.03 W | | | |
| | Ground contact edge of middle land | Inner side | Inner side | Inner side |
| | portion is on inner side or outer side | | | |
| | of 0.03 W | | | |
| | Adjacent groove width of center land | 110 | 110 | 110 |
| | portion/shoulder groove width [%] | | | |
| | Center land portion width Wc/middle | 103 | 105 | 120 |
| | land portion width Wb [%] | | | |
| | Chamfer width MW of shoulder lug | 200 | 200 | 200 |
| | groove/chamfer depth MD [%] | | | |

| | | | |
|---|---|---|---|
| Tread rubber hardness | 75 | 75 | 75 |
| Dry steering stability performance | 100 | 100 | 100 |
| Wet steering stability performance | 119 | 120 | 120 |

| | | Example 30 | Example 31 |
|---|---|---|---|
| Outer | Maximum recess amount CR1 [mm] | 0.7 | 0.7 |
| side in | of middle-land-portion-side end | | |
| vehicle | portion of center land portion | | |
| width | Maximum recess amount MR2 [mm] | 0.4 | 0.4 |
| direction | of center-land-portion-side end | | |
| | portion of middle land portion | | |
| | Difference (CR1 − MR2) [mm] | 0.3 | 0.3 |
| | Maximum recess amount MR1 [mm] | 0.4 | 0.4 |
| | of shoulder-land-portion-side end | | |
| | portion of middle land portion | | |
| | Maximum recess amount SR1 [mm] | 0.4 | 0.4 |
| | of middle-land-portion-side end | | |
| | portion of shoulder land portion | | |
| | Difference (MR1 − SR1) [mm] | 0 | 0 |
| | Ground contact edge of center land | Inner side | Inner side |
| | portion is on inner side or outer side | | |
| | of 0.03 W | | |
| | Ground contact edge of middle land | Inner side | Inner side |
| | portion is on inner side or outer side | | |
| | of 0.03 W | | |
| | Adjacent groove width of center land | 110 | 110 |
| | portion/shoulder groove width [%] | | |
| | Center land portion width Wc/middle | 110 | 110 |
| | land portion width Wa [%] | | |
| | Chamfer width MW of shoulder lug | 200 | 200 |
| | groove/chamfer depth MD [%] | | |
| Inner | Maximum recess amount CR2 [mm] | 0.7 | 0.7 |
| side in | of middle-land-portion-side end | | |
| vehicle | portion of center land portion | | |
| width | Maximum recess amount MR3 [mm] | 0.4 | 0.4 |
| direction | of center-land-portion-side end | | |
| | portion of middle land portion | | |
| | Difference (CR2 − MR3) [mm] | 0.3 | 0.3 |
| | Recess amount MR4 [mm] of | 0.4 | 0.4 |
| | shoulder-land-portion-side end | | |
| | portion of middle land portion | | |
| | Maximum recess amount SR2 [mm] | 0.4 | 0 |
| | of middle-land-portion-side end | | |
| | portion of shoulder land portion | | |
| | Difference (MR4 − SR2) [mm] | 0 | 0.4 |
| | Ground contact edge of center land | Inner side | Inner side |
| | portion is on inner side or outer side | | |
| | of 0.03 W | | |
| | Ground contact edge of middle land | Inner side | Inner side |
| | portion is on inner side or outer side | | |
| | of 0.03 W | | |
| | Adjacent groove width of center land | 110 | 110 |
| | portion/shoulder groove width [%] | | |
| | Center land portion width Wc/middle | 122 | 110 |
| | land portion width Wb [%] | | |
| | Chamfer width MW of shoulder lug | 200 | 200 |
| | groove/chamfer depth MD [%] | | |

| | | |
|---|---|---|
| Tread rubber hardness | 75 | 75 |
| Dry steering stability performance | 100 | 100 |
| Wet steering stability performance | 119 | 120 |

1. A tire comprising:
a plurality of circumferential main grooves provided in a tread portion, the plurality of circumferential main grooves extending in a tire circumferential direction; and
a plurality of land portions defined by the plurality of circumferential main grooves,
the plurality of land portions comprising:
a center land portion closest to a tire equatorial plane;
a first shoulder land portion comprising one ground contact edge of ground contact edges on both sides in a tire width direction with respect to the tire equatorial plane; and
a first middle land portion between the first shoulder land portion and the center land portion,
in a tire meridian cross-sectional view, a line connecting, by a single arc, a ground contact edge located in the first shoulder land portion, a midpoint of a length of the center land portion in the tire width direction, and a midpoint of a length of the first middle land portion in the tire width direction being defined as a first virtual profile,
an end portion of the center land portion on a side of the first middle land portion being recessed toward an inner side in a tire radial direction relative to the first virtual profile,
an end portion of the first middle land portion on a side of the center land portion being recessed toward the inner side in the tire radial direction relative to the first virtual profile,
a recess amount of the end portion of the center land portion on the side of the first middle land portion being larger than a recess amount of the end portion of the first middle land portion on the side of the center land portion, and
in the tire meridian cross-sectional view, a distance between intersection points of the first virtual profile and extension lines extended from groove walls, on sides of the center land portion, of circumferential main grooves adjacent to both end portions of the center land portion in the tire width direction being defined as Wc, and a ground contact edge of the center land portion being located on a more inner side than a position at a distance of 0.03Wc from the end portion of the center land portion on the side of the first middle land portion.

2. The tire according to claim 1, wherein
in the tire meridian cross-sectional view, a distance between intersection points of the first virtual profile and extension lines extended from groove walls, on sides of the first middle land portion, of circumferential main grooves adjacent to both end portions of the first middle land portion in the tire width direction is defined as Wa, and a ground contact edge of the first middle land portion is located on a more inner side than a position at a distance of 0.03Wa from the end portion of the first middle land portion on the side of the center land portion.

3. The tire according to claim 1, wherein a difference between the recess amount of the end portion of the center land portion on the side of the first middle land portion and the recess amount of the end portion of the first middle land portion on the side of the center land portion is 0.1 mm or more and 0.8 mm or less.

4. The tire according to claim 1, wherein a groove width of the circumferential main groove adjacent to the end portion of the center land portion in the tire width direction is equal to or larger than a groove width of a circumferential main groove adjacent to the first shoulder land portion.

5. The tire according to claim 1, wherein a length of the center land portion in the tire width direction is 105% or more and 120% or less of a length of the first middle land portion in the tire width direction.

6. The tire according to claim 1, wherein
an end portion of the first shoulder land portion on the inner side in the tire width direction is recessed toward the inner side in the tire radial direction relative to the first virtual profile, and
a recess amount of the end portion of the center land portion on an outer side in the tire width direction is larger than a recess amount of the end portion of the first shoulder land portion on the inner side in the tire width direction.

7. The tire according to claim 6, wherein
an end portion of the first middle land portion on a side of the first shoulder land portion is recessed toward the inner side in the tire radial direction relative to the first virtual profile, and
a recess amount of the end portion of the first middle land portion on the side of the first shoulder land portion is equal to or larger than a recess amount of the end portion of the first shoulder land portion on a side of the first middle land portion.

8. The tire according to claim 1, wherein
the first shoulder land portion comprises a lug groove extending in the tire width direction,
the lug groove comprises a chamfer in a groove depth direction and a groove width direction, and
a chamfer length in the groove width direction is larger than a chamfer length in the groove depth direction.

9. The tire according to claim 1, further comprising:
a second shoulder land portion comprising another ground contact edge of the ground contact edges on both sides in the tire width direction with respect to the tire equatorial plane; and
a second middle land portion between the second shoulder land portion and the center land portion, wherein
in the tire meridian cross-sectional view, a line connecting, by a single arc, a ground contact edge located in the second shoulder land portion, the midpoint of the length of the center land portion in the tire width direction, and a midpoint of a length of the second middle land portion in the tire width direction is defined as a second virtual profile,
an end portion of the center land portion on a side of the second middle land portion is recessed toward the inner side in the tire radial direction relative to the second virtual profile,
an end portion of the second middle land portion on a side of the center land portion is recessed toward the inner side in the tire radial direction relative to the second virtual profile,
a recess amount of the end portion of the center land portion on the side of the second middle land portion is larger than a recess amount of the end portion of the second middle land portion on the side of the center land portion, and
in the tire meridian cross-sectional view, a distance between intersection points of the second virtual profile and the extension lines extended from the groove walls, on the sides of the center land portion, of the circumferential main grooves adjacent to both end portions of the center land portion in the tire width direction is defined as Wc′, and a ground contact edge of the center land portion is located on a more inner side than a position at a distance of 0.03Wc′ from the end portion of the center land portion on the side of the second middle land portion.

10. The tire according to claim 9, wherein
in the tire meridian cross-sectional view, a distance between intersection points of the second virtual profile and extension lines extended from groove walls, on sides of the second middle land portion, of circumferential main grooves adjacent to both end portions of the second middle land portion in the tire width direction is defined as Wb, and a ground contact edge of the second middle land portion is located on a more inner side than a position at a distance of 0.03Wb from the end portion of the second middle land portion on the side of the center land portion.

11. The tire according to claim 9, wherein a difference between the recess amount of the end portion of the center land portion on the side of the second middle land portion and the recess amount of the end portion of the second middle land portion on the side of the center land portion is 0.1 mm or more and 0.8 mm or less.

12. The tire according to claim 9, wherein a groove width of the circumferential main groove adjacent to the end portion of the center land portion in the tire width direction is equal to or larger than a groove width of a circumferential main groove adjacent to the second shoulder land portion.

13. The tire according to claim 9, wherein a length of the center land portion in the tire width direction is 105% or more and 120% or less of a length of the second middle land portion in the tire width direction.

14. The tire according to claim 9, wherein
an end portion of the second shoulder land portion on the inner side in the tire width direction is recessed toward the inner side in the tire radial direction relative to the second virtual profile, and
a recess amount of the end portion of the center land portion on the outer side in the tire width direction is larger than a recess amount of the end portion of the second shoulder land portion on the inner side in the tire width direction.

15. The tire according to claim 14, wherein
an end portion of the second middle land portion on a side of the second shoulder land portion is recessed toward the inner side in the tire radial direction relative to the second virtual profile, and
a recess amount of the end portion of the second middle land portion on the side of the second shoulder land portion is equal to or larger than a recess amount of the end portion of the second shoulder land portion on a side of the second middle land portion.

16. The tire according to claim 9, wherein
the second shoulder land portion comprises a lug groove extending in the tire width direction,
the lug groove comprises a chamfer in a groove depth direction and a groove width direction, and
a chamfer length in the groove width direction is larger than a chamfer length in the groove depth direction.

17. The tire according to claim 1, wherein rubber constituting the tread portion has a hardness of 65 or more at 20° C.
